(19) United States
(12) Patent Application Publication
(10) Pub. No.: US 2015/0024154 A1
(43) Pub. Date: Jan. 22, 2015

(54) LABEL WEB SUITABLE FOR ACTIVATION AND CUTTING

(71) Applicant: Ted HOERIG, Strongsville, OH (US)

(72) Inventor: Ted HOERIG, Strongsville, OH (US)

(73) Assignee: UPM RAFLATAC OY, Tampere (FI)

(21) Appl. No.: 13/945,339

(22) Filed: Jul. 18, 2013

(51) Int. Cl. G09F 3/04; B23K 26/38; G09F 3/00; B65D 1/02; B32B 7/12; B32B 17/10; B32B 27/08; B32B 27/10; B65C 9/25; B32B 1/02

(52) U.S. Cl. CPC G09F 3/04; B65C 9/25; B23K 26/38; G09F 3/0295; B32B 1/02; B32B 7/12; B32B 17/1055; B32B 27/08; B32B 27/10; B65D 1/0207; G09F 2003/025
USPC 428/34.2; 156/256; 428/347; 428/212; 428/195.1; 428/35.7; 428/34.7

(57) ABSTRACT

A film including a first surface and an opposite second surface. A first layer includes the first surface. A second layer arranged onto the first layer includes the second surface. The second layer includes thermally activatable material. In a thermal activation process, wherein the temperature of the thermally activatable material rises above an activation temperature, adhesion properties of the material change such that before thermal activation, material of the second layer is solid and non-sticky, and after thermal activation, material of the second layer is viscous and forms an active adhesive. The first layer includes material that is resistant to temperatures higher than the activation temperature. Material of the first layer, material of the second layer, or the film including the first and second layers is capable of absorbing electromagnetic energy. An item including a body labelled with the film. A method for labelling a body using the film.

### FIELD OF THE INVENTION

This invention relates to films used for labelling items. This invention relates to labelled items. This invention relates to label webs and method for cutting labels from the label web. This invention relates to methods for labelling items.

### BACKGROUND OF THE INVENTION

Labels are used to label bodies to form items, i.e. labelled items. Known solutions include stickers having a face, an adhesive layer, and a release liner. After the removal of the release liner, the adhesive layer of the sticker can be used to label a body. This kind of self-adhesive labels have good dimensional stability, i.e. their dimensions remain unchanged in the labelling process. In this type of a process, cutting of the label is problematic. Preferably, only the face, and optionally the adhesive layer, is cut, but the release liner preferably remains solid during cutting. This type of cutting helps the subsequent separation of the label from the release liner. However, the precise cutting may be problematic.

It is also known to label bodies using thermally shrinkable materials. The shrinkable material may be supplied in a form of a loop, or a loop may be made of such material. A part of a body may be arranged inside the loop, whereby, after application of heat, the loop shrinks onto the part of the body thereby labelling the body and forming the labelled item.

Both these labelling processes need quite a lot of materials. For example, when labelling an item using the sticker-type labels, the release liner becomes waste, and needs to be treated as such. By using thermally shrinkable materials, relatively large labels are needed, since the label forms a loop around the body. In some applications, smaller labels suffice. Thereby using loop-type labels would consume unnecessarily large amounts of labelling material. Moreover, a smaller label may be visually more attractive than a large label.

The present invention reduces the material use in such a labelling process. Moreover, an accurate method for cutting the label will be presented.

### SUMMARY OF THE INVENTION

In accordance with the embodiments, a film for labelling a body will be presented. Unlike some of the prior films, the film does not have a release liner. Therefore, the use of materials is significantly reduced, as a release liner is not wasted. Moreover, a piece of the film can be adhered onto an item. Thus, the film needs not to be used only by forming a loop, since the adhesion is provided otherwise, i.e. via thermally activatable adhesive. Thus, in some embodiments, the film comprises material having a good dimensional stability. Furthermore, as the film does not comprise a release liner that should remain solid in a cutting process, cutting of the label becomes easy. It has been noticed, that laser cutting provides highly accurate cutting with visually appealing label boundaries. Still further, in some embodiments, the film comprises material being oriented in at least one direction, to have good flexural properties.

In an embodiment, the film has
a length, a width, and a thickness, wherein the thickness is smaller than the length and the width, the film comprising
a first surface and an opposite second surface,
a first layer having the length and the width, and comprising the first surface,
a second layer arranged onto the first layer and having the length and the width, and comprising the second surface.

In the film, the second layer comprises thermally activatable material such that
in a thermal activation process, wherein the temperature of the thermally activatable material rises above an activation temperature Ta, the adhesion properties of the material change such that
before said thermal activation, the material of the second layer is solid and non-sticky, and
after said thermal activation, the material of the second layer is viscous and forms an active adhesive; wherein
the activation temperature Ta, is from 75° C. to 135° C.;
the first layer comprises material that is resistant to some temperatures higher than Ta, and
the material of the first layer 110, the material of the second layer 120, or the film comprising the first and the second layers (110, 120) is capable of absorbing electromagnetic energy, whereby the film is suitable for laser cutting.

An embodiment of a labelled item, labelled with such a film, comprises
a body,
a first layer of first material, and
a second layer of second material, wherein
the second layer is arranged in between the body and the first layer,
the size of the area of body that is covered by the second layer is A_{b2},
the size of the area of second layer that is covered by the first layer is A₂₁,
the ratio the these areas, A_{b2}/A₂₁, is between 0.95 and 1.05,
the first layer comprises material that is resistant to temperatures higher than 90° C.,
the second layer comprises thermally activated material, wherein the thermally activated material has been thermally activated, and
the first layer and/or the second layer comprises material capable of absorbing electromagnetic energy.

Such a film may be used to label an item. Such a use comprises
heating the film or a cut label to activate the material of the second layer,
cutting, by laser, a label from the film, whereby the label comprises a first layer and a second layer these layer having been parts of the layers of the film; and
attaching the second layer of the label onto a body.

Moreover, an embodiment of a method for labelling a body to form a labelled item comprises
providing a film suitable for thermal activation and laser cutting, such as the film of any of the examples 1.1 to 1.34, the film having
   a length, a width, and a thickness, wherein the thickness is smaller than the length and the width, and the film comprising
   a first surface and an opposite second surface, wherein the surfaces have their surface normals parallel to the direction of the thickness,
   a first layer having the length and the width; and comprising the first surface
   a second layer arranged onto the first layer and having the length and the width; and comprising the second surface, wherein
   the second layer comprises thermally activatable material such that
      in a thermal activation, wherein the temperature of the thermally activatable material rises above an activation temperature Ta, the adhesion properties of the material change such that
      before said thermal activation, the material of the second layer is solid and non-sticky, and
      after said thermal activation, the material of the second layer is viscous and forms an active adhesive; wherein
   the activation temperature Ta, is from 75° C. to 135° C.;
   the first layer comprises material that is resistant to temperatures higher than Ta, and
   the first layer and/or the second layer comprises material capable of absorbing electromagnetic energy, whereby the film is suitable for laser cutting; and
heating the film or a cut label to activate the material of the second layer,
cutting, by laser, a label from the film, whereby the label comprises a first layer and a second layer these layers having been parts of the layers of the film; and
attaching the second layer of the label onto a body.

Other features of the film, the labelled item, the use, and the method are disclosed in the examples.

### DESCRIPTION OF THE DRAWINGS

FIG. 1a shows, in a side view, a film,

FIG. 1b shows, in a perspective view, the film of FIG. 1a,

FIG. 2a shows, in a perspective view, a film comprising markings on a first surface,

FIG. 2b shows, in a perspective view, a film comprising markings on a second surface,

FIG. 3 shows a planar view of a web of film, cuttings in the web, labels made by said cutting, and the remainder of the web,

FIG. 4a shows a planar view of a use of the film and a process for labelling a body using the film,

FIG. 4b shows a planar view of another use of the film and another process for labelling a body using the film,

FIG. 4c shows a planar view of another use of the film and another process for labelling a body using the film,

FIG. 4d shows a planar view of another use of the film and another process for labelling a body using the film, and

FIG. 5 shows a planar view of a parallel process for labelling multiple bodies.

### DETAILED DESCRIPTION OF THE EMBODIMENTS

It has been noticed that in particular for labelling items, a film comprising thermally activatable adhesive solves some of the problems described above. When thermally activatable adhesive is used, no release liner is needed. Moreover, a reasonably small label can be used. The term “thermally activatable adhesive” refers to material that can be thermally activated by thermal activation, i.e. using heat. Such material may also be referred to as “heat activated adhesive”, “heat activated material”, “heat activatable material”, or “heat activatable adhesive”. In this description the term “activatable” refers to the potential of the material of being activated; before it actually is activated. In this description, the term “activated” refers to the material after having been activated. A thermally activatable material has the following properties:
Before said thermal activation, the material is solid and non-sticky. By solid it is meant that the viscosity is high. The viscosity of solid material may be e.g. at least 100 000 Pas at the temperature 20° C. A non-sticky body may be also referred to as tack free. A surface can be referred to being tack free, when an object, when pressed to the body, does not stay attached. The object does not stay attached, e.g. if gravitational force is sufficient for detaching the object from the body after said pressing. The adhesion strength, after pressing, may be e.g. at most 1 N/m². The pressing may be made e.g. with a pressure of at least 10 N/m²; optionally at most 1 MN/m² (in order not to break a body that is labelled). In the alternative, the tackiness of the surface can be determined by placing a polyethylene film on the tested surface, and then peeling it away. The surface is tack free when no adhesive is carried with the removed film.
In a thermal activation process, wherein the temperature of the thermally activatable material rises above an activation temperature Ta, the adhesion properties of the material change. The activation temperature, Ta, is more than the typical storage temperature, and preferably reasonably low so that other related materials do not melt, and heating can be done reasonably easily. The activation temperature Ta may be e.g. from 75° C. to 135° C.; and preferably from 90° C. to 125° C.
After said thermal activation, the thermally activated material is viscous and forms an active adhesive, i.e. a tacky adhesive. By viscous it is meant that the viscosity is lower than in the solid state. The viscosity of viscous adhesive may be e.g. at most 2000 Pas at the temperature 20° C.; preferably at most 500 Pas at the temperature 20° C. or at most 100 Pas at the temperature 20° C. A surface can be referred to as comprising active adhesive or tacky adhesive, when a light object, when pressed to the surface, stays attached; i.e. it does not drop off only by gravitational forces of the object. The adhesion strength, after pressing, may be e.g. at least 100 N/m². The pressing may be made e.g. with a pressure of at least 10 N/m²; optionally at most 1 MN/m². In the alternative, the tackiness of the surface can be determined by placing a polyethylene film on the tested surface, and then peeling it away. The surface comprises active adhesive or tacky adhesive, when some adhesive is carried with the removed film.

After said thermal activation, the adhesive properties of the thermally activated material (i.e. adhesive) may be similar to some adhesives known as self adhesives, self stick adhesives, and pressure sensitive adhesives. The terms “self adhesive”, “pressure sensitive adhesive”, and “self stick adhesive” all refer to an adhesive that forms a bond when pressure is applied to join the adhesive with the adherend.

The expression “forms a bond” refers to bonding by pressing an object to the surface, and to the properties of the bond such formed. These properties were discussed above. The tests can be performed e.g. at the temperature 25° C. The detaching by gravitational forces may not occur immediately; in the above, the part that falls off from the surface is considered to detach from the surface, if and only if it falls off during the first day (24 hours) once the surface has been oriented for the test.

It has also been noticed, that laser cutting provides highly accurate cutting with visually appealing label boundaries.

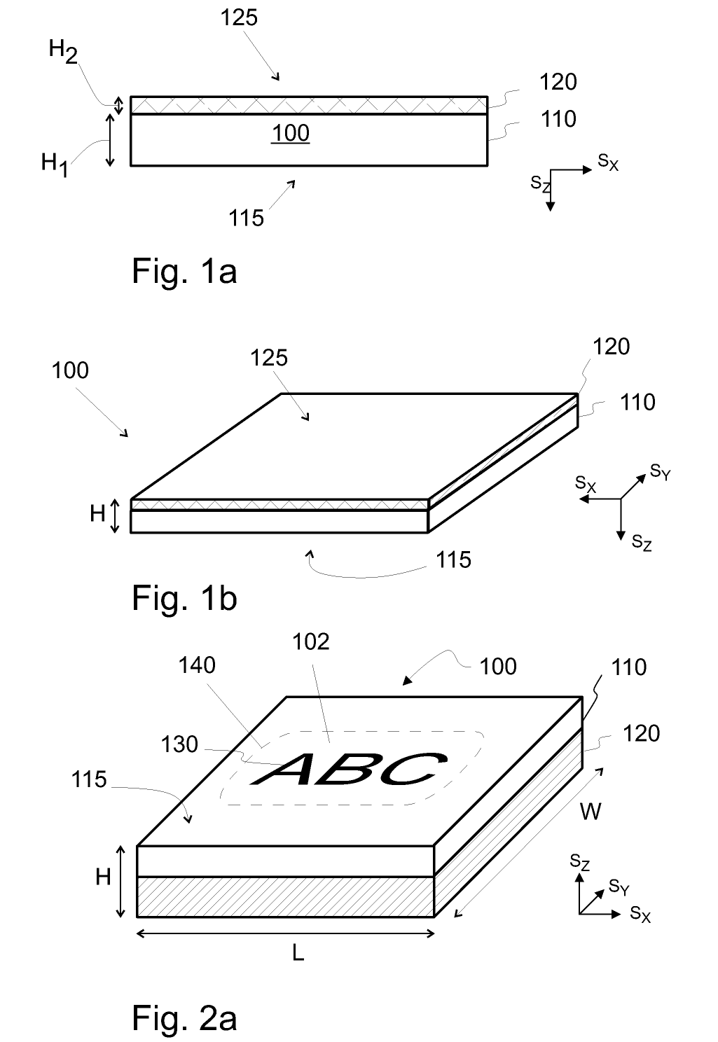

FIG. 1a shows, in a side view, an embodiment of a film suitable for thermal activation and laser cutting. The film 100 is shown in a perspective view in FIG. 1b. The film has a length L, a width W, and a thickness H, wherein the thickness H is smaller than the length L and the width W; i.e. H<min(L,W). Typically the film is thin relative to either the length of the width. Thus, in many cases H<0.1 xmin(L,W); also in many cases H<0.01 xmin(L,W).

The film 100 comprises a first surface 115 and an opposite second surface 125. These surfaces have their surface normals parallel to the direction of the thickness, Sz. This is true also for a bent film, wherein the direction of surface normal and the thickness at the same location are parallel. As depicted in the figures, the film 100 comprises a first layer 110 and a second layer 120. both these layers has the same cross-sectional area as the film itself. I.e. the second layer covers the first layer from one side, and vice versa. Moreover both of these layers are surface layers, i.e. no release liner is placed e.g. on the second layer 120. The first layer 110 may be called the face 110. The second layer 120 may be called the adhesive layer 120, the activatable layer 120, or even the activated layer (after thermal activation).

Thus, the film 100 comprises
a first layer 110 having the length L and the width W; and comprising the first surface 115, and
a second layer 120 arranged onto the first layer 110 and having the length L and the width W; and comprising the second surface 125.

The second layer 120 comprises thermally activatable material in the sense discussed above. Therefore, the second layer comprises thermally activatable material such that
in a thermal activation process, wherein the temperature of the thermally activatable material rises above an activation temperature Ta, the adhesion properties of the material change such that
before said thermal activation, the material of the second layer is solid and non-sticky, and
after said thermal activation, the material of the second layer is viscous and forms an active adhesive.

In an embodiment, the thermally activatable material of the film is selected such that the activation temperature Ta of the material is from 75° C. to 135° C.; preferably from 90° C. to 125° C.

The thermal activation of the adhesive material of the layer 120 is an irreversible activation process. By the irreversibility it is meant that the activated material has its adhesive properties even if the temperature drops below the activation temperature. Thus, e.g. hot melt adhesives are not classified as thermally activatable adhesives. Thus, in this context, after said thermal activation, the material of the second layer 120 is viscous and/or forms an active adhesive even if the temperature of the material of the second layer 120 drops below the activation temperature Ta; optionally also when the temperature of the material of the second layer 120 drops below the activation temperature Ta by at least 10° C. (i.e. the temperature of the material drops to Ta −10° C.), or by at least 20° C. The material of the second layer 120 may be in activated state (after activation) also at room temperature (25° C.).

In an embodiment, the second layer 120 comprises material that stays, after said thermal activation, in the tacky adhesive form for at least 2 seconds, preferably at least 5 seconds; optionally at most a year, at most a month, or at most seven days.

Moreover, the first layer 110 comprises material that is resistant to some temperatures higher than the activation temperature Ta. The term “resistant to some temperatures higher than the activation temperature Ta” means that at least some temperatures higher than Ta exists, wherein the material of the first layer 110 is stable. The stability here means e.g. that the material does not melt or burn. Moreover, in some embodiment, the stability means
dimensional stability (the material does not shrink; or shrinks at most 5%),
optical stability (the optical properties do not change; or at least one of them changes at most 5%), and/or
mechanical stability (the mechanical properties do not significantly change; or at least one of them changes at most 5%); e.g. the glass transition temperature of the material of the first layer 110 may be higher than Ta.

In some embodiments, the first layer 110 is resistant all temperatures exceeding the activation temperature Ta by at most 10° C., preferably by at most 25° C., such as at most 50° C. In an embodiment, the first layer does not comprise material having a melting temperature that is lower than Ta+10° C., Ta+25° C., or Ta+50° C.

Still further, the first surface 115 formed by the first layer 110 is solid and tack-free in the aforementioned sense. This is because the labels would adhere a lot of dirt, and feel uncomfortable, if their face was tacky.

Moreover, the material of the first layer 110, the material of the second layer 120, or the film comprising the first and the second layers (110, 120) is capable of absorbing electromagnetic energy, whereby the film is suitable for laser cutting.

The capability of absorbing electromagnetic energy depends on at least three factors, optionally six factors:
the reflectivity of a surface (115, 125) of the film,
the transmittance of the boundary between the first and second layers (110, 120), and
the absorption coefficient α₁ of the material of the first layer 110,
the thickness of the first layer 110,
the absorption coefficient α₂ of the material of the second layer 120,
the thickness of the second layer 120.

All these factors may be, and in general are, dependent on the wavelength of the radiation, such as the wavelength of the cutting laser. In particular, the optical properties of the face 110 are important, since in many labelling processes, the laser cutting is performed from the face side. Moreover, typically the face 110 is thicker than the adhesive layer 120.

According to Beer-Lambert law, the transmissivity of a layer of material is defined as l/I0=exp(−αₗHₗ), wherein Hₗ is a thickness of a layer, αₗ the absorption coefficient of the material of the layer, I0 the intensity of incoming radiation (to the layer, after reflections of a surface) and I the intensity of outgoing radiation. I0, l, and αₗ depend of wavelength of the light. In general, the absorption coefficient depends on the wavelength. Moreover, the reflective properties of the surface (e.g. 115) may depend on the wavelength.

In the following “visibly light” (or VIS) refers to light having a wavelength from 360 nm to 750 nm. In the following “infrared light” (or IR) refers to light having a wavelength more than 750 nm. In the following “ultraviolet light” (or UV) refers to light having a wavelength less than 360 nm.

In general the face 110 may be transparent or opaque. For a transparent film, the absorption coefficient, for visibly light, is relatively low. For example, the absorption coefficient of pure liquid water is from about 0.01 m⁻¹ to about 1 m⁻¹ at the wavelength range from 300 nm to 800 nm.

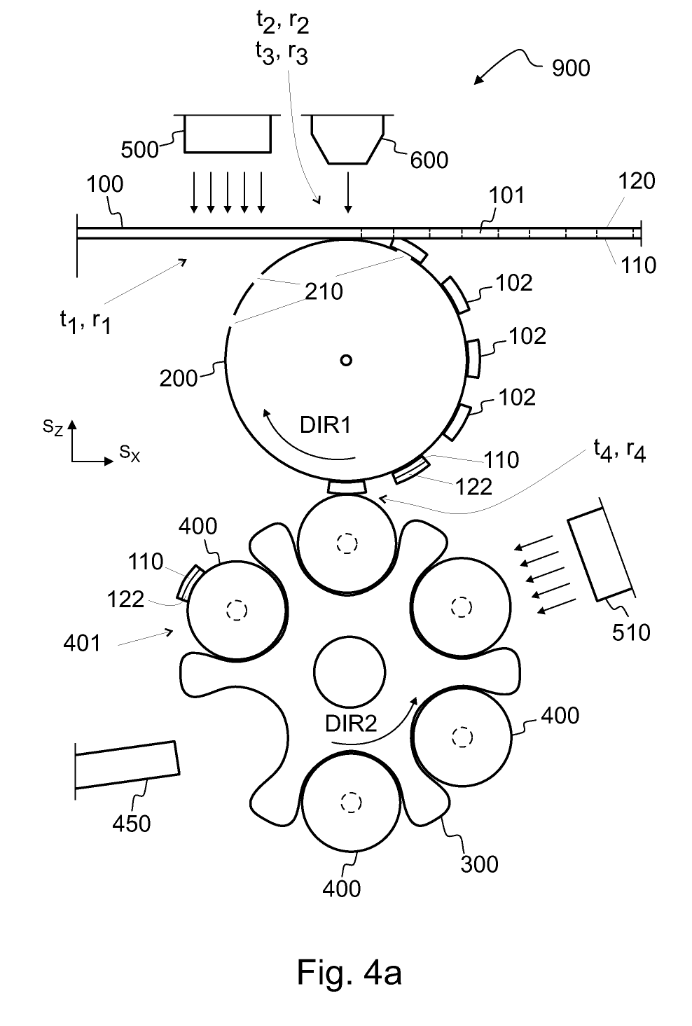

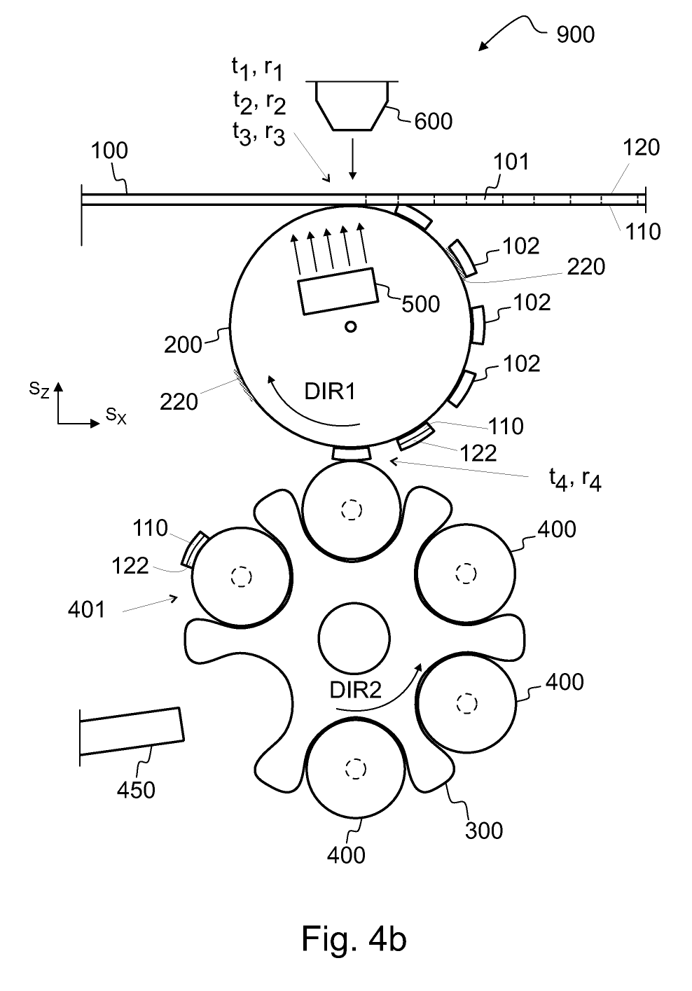

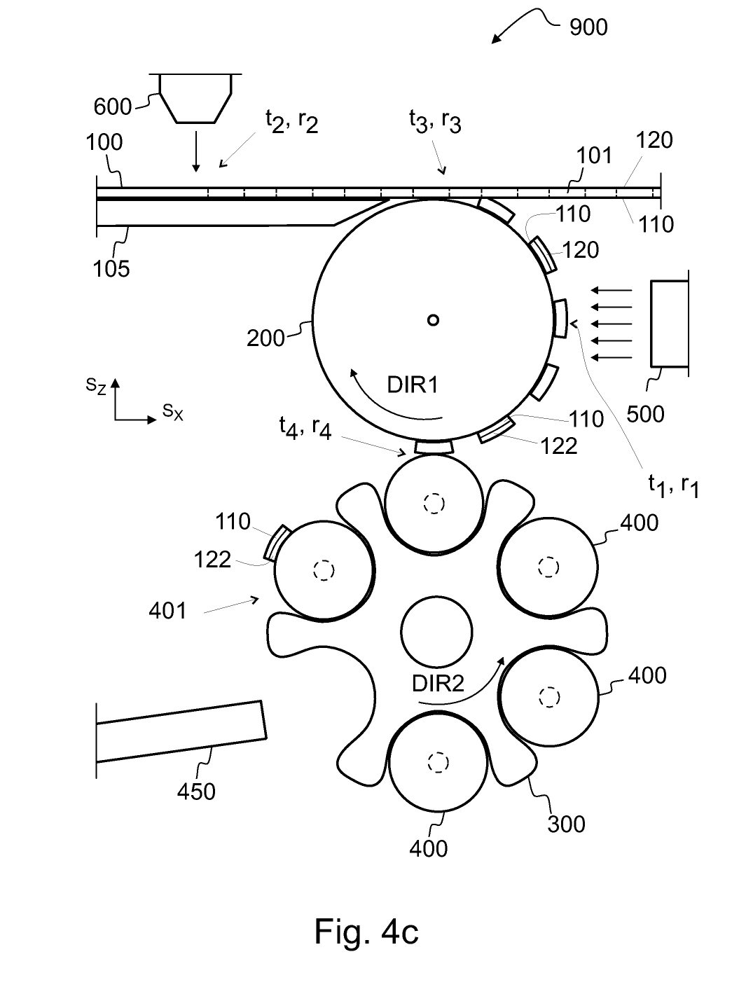

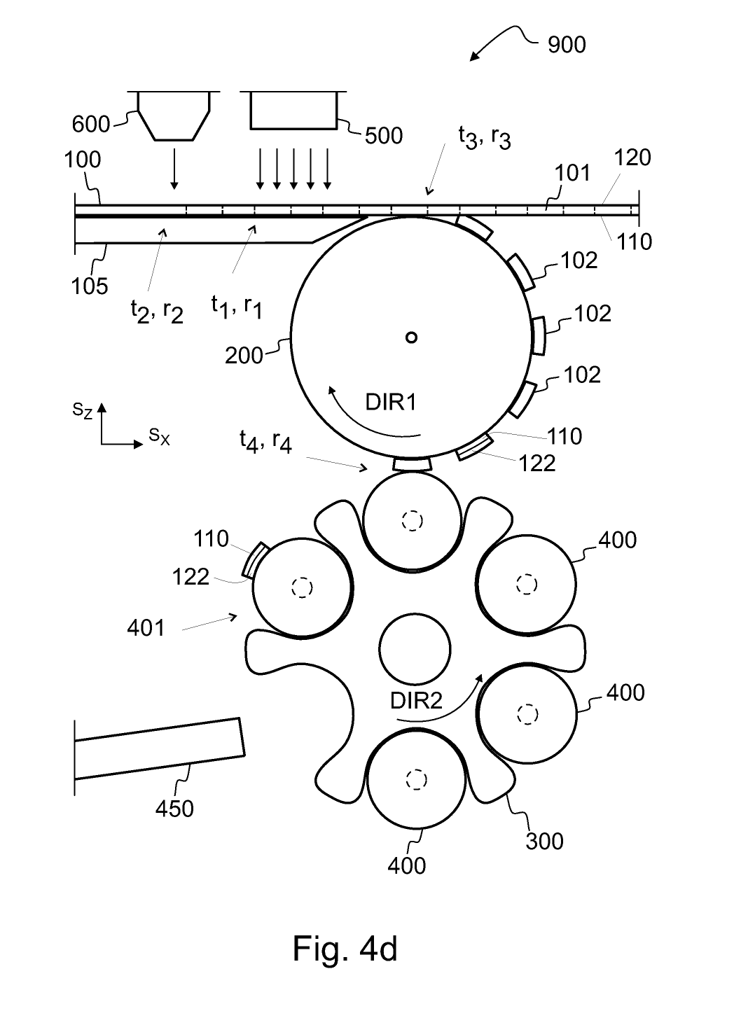

Referring to FIGS. 3 and 4a to 4d, the film 100 can be used to label items. The film 100 may form a web 100. Initially the web 100 is uncut. However, as labels 102 a cut out from the web 100, a cut web 101 is produced. The cut web 101 is also referred to as the remaining web 101. FIG. 3 shows a web 100 of the film in a side view. FIGS. 4a to 4d show the process of labelling in a top view.

It is noted that the term “side view” here does not mean that in all embodiments the direction S_{Y} (perpendicular to both S_{X} and S_{Z}; cf. FIG. 3) would be vertical or substantially vertical. It is noted that the term “top view” here does not mean that in all embodiments both the directions S_{Z} and S_{X} (cf. FIGS. 4a to 4d) would be horizontal or substantially horizontal. These terms here only define two mutually perpendicular planar views of the situation. For example, in the embodiments of FIGS. 4a and 4b, the directions S_{X} and S_{Z} may be e.g. horizontal, corresponding to the case, wherein S_{Y} would be vertical. However, in the embodiments of FIGS. 4c and 4d, the directions S_{X} and S_{Y} may be e.g. horizontal, corresponding to the case, wherein S_{Z} would be vertical.

Referring to FIG. 3, at some point, a cut 140 is made to the web 100, and thereby a label 102 is cut from the web 100. After cutting, the label 102 can be separated from the remaining web 101. In FIG. 3, the reference number 102a refers to a label that is next detached from the web 100. In practice, all cut labels 102 will be detached from the web 100 and attached onto a body. When the label 102 is used, a cut web 101 remains. The cut web comprises holes 104. The cut web 101 may be treated as waste.

Referring to FIGS. 4a to 4d, in the labelling process, the film 100 (or the web 100, or a cut label 102) is heated, to activate the thermally activatable material, using a heater 500. More specifically, in FIGS. 4a and 4d, the film 100 is heater; while in FIG. 4c, the cut label 102 is heated. The heater 500 of FIG. 4b heats both the film 100, at the point where it contacts the film, and the cut label 102. In addition a label 102 (or the label 102) is cut (or has been cut) using a laser 600. Preferably these steps are performed in a single device 900. As depicted in the figures, several labels 102 are cut from the film 100. The system may comprise a support 105 (FIGS. 4c and 4d), arranged to support a cut label 102 on its proper location. This may be the case e.g. when the label 102 is cut from the film 100 before it is separated from the film. As indicated in the figures, and clear from the above discussion, a cut label 102 also comprises a first layer 110 and a second layer 120 these layer having been parts of the layers (110, 120) of the film. The layers (110, 120) of the cut label 102 and the layer (110, 120) of the film 100 are denoted with same reference numbers, as their technical properties (other than the size in the plane of the label 102) are the same.

A cut label 102 is separated from the film 100. Preferably a roller 200 is used to separate the label 102 from the film 100 (or the cut film 101). Referring to FIGS. 4a to 4d, the roller may be arranged to rotate, or it may rotate, in the direction DIR1. The roller 200 may be e.g. an anvil roller. The roller 200 comprises means for holding a label 102 from the first layer 110 or from the surface 115 of the first layer 110. As discussed above, the surface 115 of the first layer 110 is tack free. Therefore, the means for holding a label 102 from the first layer 110 or from the surface 115 of the first layer 110 may comprise a suction device, such as a low pressure pump or a vacuum pump. Thus, the pressure inside the roller may be lower that outside the roller. Moreover, the roller 200 may further comprise holes 210 (FIG. 4a) to suck the label 102 to the surface of the roller 200 by means of this pressure difference. In addition or alternatively, the roller 200 may comprise suction pads 220 or suction cups 220 (FIG. 4b) as the means for holding a label 102 from the first layer 110 or from the surface 115 of the first layer 110. As seen from the figures, also the first surface 115 of the first layer 110 of the film 100 is arranged to face the surface of the anvil 200.

After separation, cutting, and heating, the label 102 is attached to a body 400 to form a labelled item 401. A transporting apparatus 300 is used to transfer the bodies 400 to be labelled to the location, wherein the labels 102 are attached to the bodies 400. The transporting apparatus 300 may have a rotating part, arranged to rotate (or rotating) in another direction DIR 2. The other direction DIR2 may be reverse to the first direction DIR1 (cf. FIGS. 4a to 4d). A conveyor 450 may be used to convey the labelled items 401 from the transporting apparatus 300 to further use.

In the following, when necessary, the thermally activated second layer 120 will be denoted with the reference number 122.

Referring to FIG. 4a, in an embodiment, the film 100 is heated, and thereafter, a label 102 is cut from the heated film. The separation of the label 102 from the film 100 may occur substantially at the same time as the cutting. As depicted in the figure, the cut labels 102 comprise thermally activated second layer 122. The material of the activatable layer 120 is activated by the heater 500 to the activated material 122.

Referring to FIG. 4b, in an embodiment, the film 100 is heated and the label 102 is cut substantially at the same time. Furthermore, the separation of the label 102 from the film 100 occurs substantially at the same time as the cutting and heating. As depicted in the figure, the cut labels 102 comprise thermally activated second layer 122. The roller 200 may comprise a heater 500.

Referring to FIG. 4c, in an embodiment, the labels 102 are first cut from the film, and thereafter, the labels 102 are separated from the film. Thereafter the cut labels 102 may be heated to activate the adhesive. In this embodiment, provided that the direction S_{Z} is vertical, a support 105 may be used to support the cut labels 102 on a proper location. The support 105 may be e.g. a conveyor belt. As depicted in the figure, some of the cut labels 102 comprise thermally activatable second layer 120. After the thermal activation by the heater 500, these label comprise thermally activated material 122.

Referring to FIG. 4d, in an embodiment, the labels 102 are first cut from the film, and thereafter, the remaining film 101 together with the cut label 102 is heated. Thereafter the cut labels 102 are separated from the remaining web 101. Also in this embodiment, the direction S_{Z} may be vertical, and a support 105 may be used. As depicted in the figure, the cut labels 102 comprise thermally activated second layer 122.

As discussed, such a film, or any other embodiment of the film, can be used to label a body. Such a use comprises
heating the film 100 or a cut label 102 to activate the material of the second layer 120,
cutting, by laser, a label 102 from the film 100; whereby the label 102 comprises a first layer 110 and a second layer 120 these layers having been parts of the layers (110, 120) of the film 100, and
separating a cut label 102 from the film 100.

These steps may be performed in any order or simultaneously, such that the separating is not performed before the cutting. As indicated above, the order of the process steps may be e.g.
cutting, heating (i.e. activating), and separating;
heating (i.e. activating), cutting, and separating; or
cutting, separating, and heating (i.e. activating).

Two subsequently listed steps can be performed simultaneously.

After these steps, the use comprises
attaching the second layer 120 (i.e. the thermally activated second layer 122) of the label 102 onto a body 400.

In such a use, a method for labelling a body is performed. The method comprises
providing a film 100 suitable for thermal activation and laser cutting, the film having the aforementioned properties;
heating the film 100 or a cut label 102 to activate the material of the second layer 120;
cutting, by laser, a label 102 from the film 100 and separating the label 102 from the film 100; whereby the label 102 comprises a first layer 110 and a second layer 120 these layers having been parts of the layers (110, 120) of the film 100;
separating a cut label 102 from the film 100; and
attaching the second layer 120 of the label 102 onto a body 400.

As depicted in FIGS. 4a to 4d, bodies 400, such as containers, may be labelled in a process, such as a process for manufacturing labelled items. However, the body may also refer to a parcel in general, and the method may be performed in a normal warehouse. Thus, also regular parcels can be labelled using the method. The bodies 400 may comprise plastic material. The parcels in general may comprise paper or cardboard on their surface. The thermally activatable adhesive 120 may be selected according to the targeted use; in particular, onto what material the label is to be attached.

Referring to FIGS. 4a to 4d, in the use of the label or the method for labelling,
a film (FIG. 4a) or a cut label (FIGS. 4c and 4d) is heated at a first time t₁ and in a first location r₁. In particular, in case the film is heated (FIG. 4a), the part of a film, from which the label 102 is to be cut is heated at the first time t₁. Other parts of the film 100 may be heated later, or other parts of the cut web 101 may have been heated earlier, as is evident from the FIGS. 4a to 4d.
the label 102 is laser cut from the film 100 or the web at a second time t₂ and in a second location r₂.
the label 102 is separated from the web (100, 101) at a third time t₃ and in a third location r₃.
the label 102 is attached to a body 400 at a fourth time t₄ and in a fourth location r₄.

In the temporal sense, attaching the label typically occurs last. In these embodiments, t₄>max(t₁,t₂,t₃). However, provided that the body 400 comprises a projection, onto which a label is attached, it is, in principle possible to attach the (unseparated) label to the projection, and only afterwards detach the label from the web by the removal of the body. In principle also the laser cutting could be in this case made after attaching the projection of the body to the film. Moreover, a label 102 cannot be detached from the web before the label is cut; however these may happen substantially simultaneously (FIGS. 4a and 4b). Thus, t₃≧t₂. Heating (i.e. the time t₁) may be before, after, or simultaneously with laser cutting.

In an embodiment, the fourth time is later than the later of the first time and the second time, i.e. t₄>max(t₁,t₂). Moreover, t₁ may be less than t₂; t₁ may be greater than t₂; or t₁ may be equal to t₂.

In this use or process, a labelled item 401 is formed. Since the label 102 has been cut from a film 100, the sizes of the first and the second layers of the label on the body 400 are substantially the same. Such a labelled item 401 comprises
a body 400,
a first layer 110 of first material, and
a second layer 122 of second material, wherein
the second layer 122 is arranged in between the body 400 and the first layer 110,
the size of the area of body 400 that is covered by the second layer 122 is A_{b2},
the size of the area of second layer 122 that is covered by the first layer 110 is A₂₁,
the ratio the these areas, A_{b2}/A₂₁, is from 0.95 to 1.05,
the first layer 110 comprises material that is resistant to temperatures higher than 90° C., preferably higher than 100° C., and more preferably higher than 120° C.,
the second layer 122 comprises thermally activated material, and
the first layer 110 and/or the second layer 122 comprises material capable of absorbing electromagnetic energy.

It is noted that the reference number 122 is used for the thermally activated second layer 120. Moreover, the ratio A_{b2}/A₂₁ is not necessarily exactly one, since some of the activated adhesive may be squeezed out during labelling and/or the materials of the layers 110, 122 may undergo thermal contraction. Preferably the ratio A_{b2}/A₂₁ is from 0.99 to 1.01.

The first layer 110 may comprise material that has a melting point of at least 90° C., preferably at least 100° C., and more preferably at least 120° C.

In the labelled item 401, the thermally activated material of the second layer 122 has been thermally activated from the thermally activatable material of the second layer 122, as discussed above. The thermally activated material may be viscous in the sense discussed above. The thermally activated material may be tacky in the sense discussed above. The thermally activated material may lose one or more of its adhesive properties over a long period of time, whereby these features are not necessarily present in the labelled item.

As is clear, many of the properties of the first layer 110 and/or the second layer 122 of the labelled item 401 are inherited from the film 100 itself. Moreover, some properties of the use or method for labelling may depend on the properties of the film 100. Therefore, properties related to some embodiment of the film 100 will be discussed below.

### Details of Films

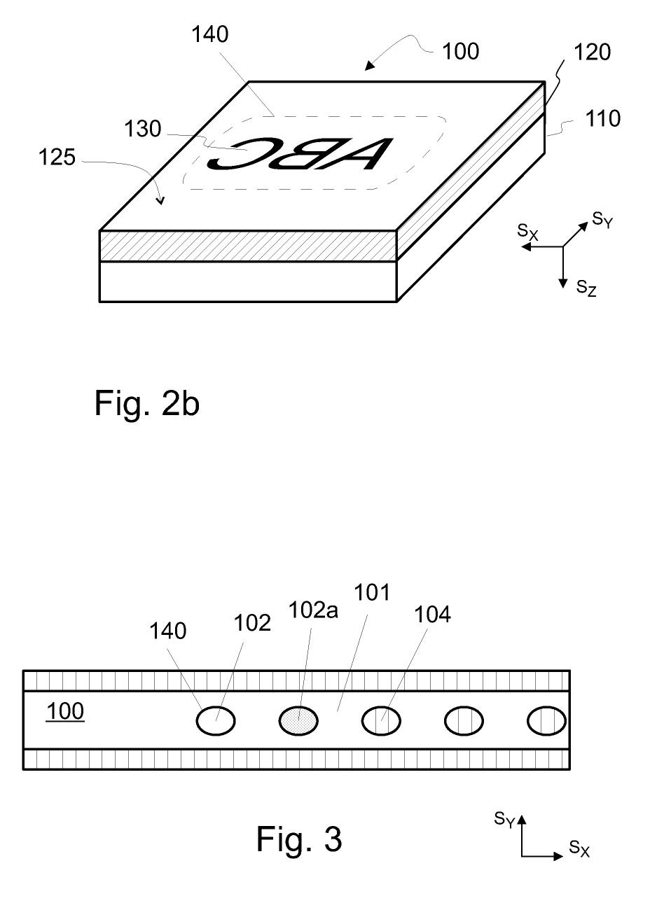

As the film 100 is used for labelling, the film may comprise markings, or may be printable. Referring to FIGS. 2a and 2b, the film 100 may comprise markings 130 arranged on the first surface 115, i.e. on the face 110 (FIG. 2a). In addition or alternatively, e.g. when the face 110 and the second layer 120 are transparent, markings 130 may be arranged on the second surface 125, i.e. on the adhesive layer 120 (FIG. 2b). The markings 130 on the second surface 125 may be printed in such a manner that they are correctly readable through the first layer 110. In addition or alternatively, e.g. when the first layer 110 is transparent, markings may be arranged in between the first layer 110 and the second layer 120 (not shown). These markings may be printed in such a manner that they are correctly readable through the first layer 110. Such markings may be printed e.g. on a surface of the first layer 110 before the application of the heat activatable material onto the printed surface.

In the alternative, a film without any markings may be supplied. In this case the film comprises a printable surface, such as the first surface 115 or the second surface 125. In such a film at least one of the first surface 115 and the second surface 125 is printable. Preferably the surface 115 of the face 110 is printable. Printability may be described by the surface tension of the surface. Surface tension may be measured according to the standard ISO 8296. When a surface, such as the surface of the film 100, is printable, the surface that is printable has a surface tension from 36 mN/m to 46 mN/m, preferably from 38 mN/m to 44 mN/m. Quite commonly the surface tension is expressed in units dynes/cm. For example, the print receiving surface (115, 125) may have a surface tension at least 36 dynes/cm, preferably at least 38 dynes/cm or at least 44 dynes/cm measured according to the standard ASTM D-2578 (e.g. the latest version available on 1, Jul. 2013). The surface tension may be between 36 and 60 dynes/cm, preferably between 38 and 56 dynes/cm or between 44 and 50 dynes/cm.

In an embodiment, the first layer 110 comprises plastic polymer. The first layer 100 may itself be a layered structure, comprising at least two sub-layers of different material. In the alternative, the first layer 110 may comprise only one layer of material. In an embodiment, the first layer 110 comprises at least one of polypropylene (PP), polyethylene (PE), a blend consisting of polypropylene (PP) and polyethylene (PP), polyester; and polyvinylchloride (PVC). The face may further comprise e.g. pigments that affect the colour and transparency of the film, as will be discussed. The pigments may be mixed with the polymer matrix material. Polyethylene terephthalate (PET) is an example of polyesters.

In an embodiment, the face 110 comprises at least one layer (or sub-layer) that consist of polymer material. In an embodiment, the face 110 comprises at least one layer (or sub-layer) that consist of only one polymer material selected from the group of the following five plastics: (1) polypropylene (PP), (2) polyethylene (PE), (3) a blend consisting of polypropylene (PP) and polyethylene (PP), (4) polyester; and (5) polyvinylchloride (PVC). An example of particularly suitable polyester is polyethylene terephthalate (PET). In an embodiment, the face 110 further comprises a metal sub-layer and/or a paper sub-layer. In particular, the face may comprise a polymer layer that consist of one of PP, PE, polyester, and a blend of PP and PE; wherein the polymer layer metalized with a metal foil. In particular, the face may comprise a polymer layer that consist of one of PP, PE, polyester, and a blend of PP and PE; wherein the polymer layer is further attached to a paper layer.

It has been noticed that both the polypropylene (PP) and a polyester, such as polyethylene terephthalate (PET) suit well for thermal activation and laser cutting e.g. for their thermal resistance. In addition, a composition comprising (or consisting of) both PP and polyethylene seems suitable for the purpose. This applies for overlayered (e.g. metalized) films, pigmented films and clear films.

As for polypropylene (PP), the glass transition temperature of PP is so low, that the transition temperature is not passed during thermal activation process. The glass transition temperature PP is typically below about 0° C., and during thermal activation, the temperature may be raised e.g. from about +20° C. to the activation temperature. Passing the glass transition temperature generally alters the thermo mechanical properties of the material, the coefficient of thermal extension in particular. Thus, passing the glass transition temperature may reduce the dimensional stability of the film during thermal activation. Thus for PP the dimensional stability is good. Moreover, the melting point of PP depends to some extent on the composition, and may very e.g. from 130° C. (for syndiotactic PP) to 171° C. (for isotactic PP). Typical commercial isotactic PP has a melting point in the range 160° C. to 166° C. These values are sufficient for the material to withstand the thermal activation process.

As for polyesters, their melting point is typically above 200° C. More specifically, as for polyethylene terephthalate (PET), the glass transition temperature is about 74° C., whereby the glass transition temperature may be passed in thermal activation. However, the heat resistance, in terms of melting point, of PET is much better. The melting point of PET is typically about 265° C., or more than 250° C.

In contrast, the thermal resistance of (pure) polyethylene is much lower; typically in the range from 105° C. to 130° C. However a blend of buth PP and PE has higher melting point. Moreover, the polyvinylchloride starts to decompose at about 140° C. Thereby, the use of these materials alone as the face material, requires that the activation temperature of the activatable layer 120 is reasonable low.

Thus, a face 110 preferably comprises at least one of polypropylene and polyester. In an embodiment, the face consist of exactly one of (i) polypropylene (PP), (ii) a blend of polypropylene (PP) and polyethylene (PE), and (iii) polyester, such as polyethylene terephthalate (PET); any of these three (i-iii) optionally mixed with a pigment.

In order to run smoothly in a production process, the material of the film 100 should allow for some deformations, yet it should be reasonably stiff and resistant to stretching and bending. These mechanical properties are in general described by the Young's modulus of the material. In some embodiments, the Young's modulus of the material of the first layer is at most 10 GPa, preferably at most 6 GPa, such as at most 5 GPa, as measured at the temperature 25° C. In some embodiments, the Young's modulus of the material of the first layer is at least 0.5 GPa, such as at least 1 GPa or at least 1.3 GPa, as measured at the temperature 25° C.

In general, the flexural stiffness of an isotropic elastic film depends on the Young's modulus and the thickness, and the flexural stiffness is proportional to EH³, wherein H is the thickness and E the Young's modulus. Preferably the flexural stiffness of the film, as defined by EH³, is at least 4 μNm, preferably at least 15 μNm, and more preferably at least 25 μNm. Optionally, the flexural stiffness is at most 2000 μNm, such as at most 1500 μNm, such as at most 1000 μNm. A reasonably high stiffness enables holding the label 102 from a small spot, without the label being bent. As the flexural stiffness is mainly dependent on the properties of the face 100, preferably the flexural stiffness of the face 110, as calculated by E₁H₁³, wherein E₁ is the Young's modulus of the face 110 and H₁ is the thickness of the face 110, is within the aforementioned values.

It has also been observed, that the flexural stiffness may depend on the orientation of the film. During manufacturing of the face 110, the face material may be drawn (stretched) at least in one direction. The face 110 may be drawn in a machine direction, in a transverse direction, or both. The resulting film is thus monoaxially (uniaxially) oriented (MO) or biaxially oriented (BO). A monoaxially oriented film may be either machine direction oriented (MDO) or transverse direction oriented (TDO) in accordance to the direction of the orientation (of stretching), but not in both directions. A biaxially oriented (BO) film is both machine direction oriented (MDO) and transverse direction oriented (TDO) in accordance to the direction of the orientation (stretching); i.e. a biaxially oriented film is stretched both in the MD and the TD during manufacturing.

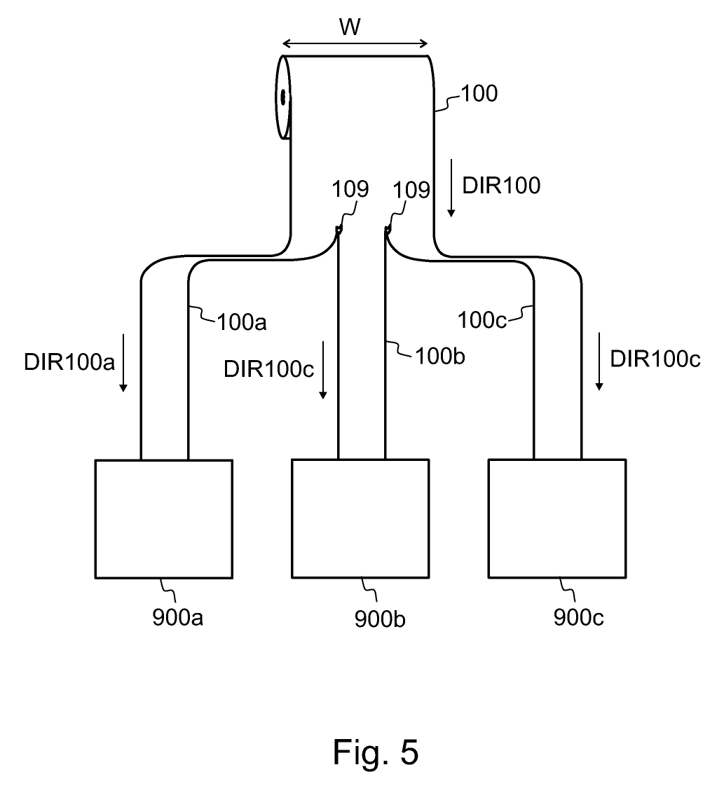

A film, when manufactured and coming out of the machine, is typically rolled to form a roll. As known, the roll has an axis of rotation, around which the roll is rotated during said rolling. The transverse direction (TD) is parallel to the axis of rotation, and thus also in plane of the film. The machine direction, on the other hand, is also in the plane of the film, and perpendicular to the transverse direction. The length of the rolled film, in the MD, may be from tens of meters upwards. The width of the rolled film, in the TD, is less, such as a few meters. The whole roll may be cut to narrower label bands according to use, prior to use. After such cutting, also the narrower rolls comprise film having the same, relatively long, length; only the width decreases in this kind of cutting. In addition or alternatively, a wide roll may be cut to narrower bands during use, as depicted in FIG. 5.

A ratio of total film thickness before and after stretching is called a “draw ratio” or “drawing ratio” (DR). It may also be referred to as a stretching ratio or orientation ratio. In other words, draw ratio is a non-oriented (undrawn) film thickness in relation to the oriented (drawn) film thickness. The non-oriented film thickness is the thickness after extrusion and subsequent chilling of the film. When stretching the film, the thickness of the film may diminish in the same ratio as the film stretches or elongates. For example, a film having thickness of 100 micrometres before monoaxial orientation is stretched by a draw ratio of 5. After the monoaxial orientation the film may have a fivefold diminished thickness of 20 micrometres. During stretching the randomly oriented polymer chains of the extruded films are oriented in the direction of stretching (drawing). Orientation under monoaxial stress provides orientation of polymer chains of the plastic film in the direction of stress provided. In other words, the polymer chains are oriented at least partially in the direction of stretching (drawing). During manufacturing, the film may have been stretched in the at least one direction with a ratio of unstretched film thickness to stretched film thickness between 2 and 10. In other words, the film may have been stretched in the at least one direction with a stretching ratio of between 2:1 and 10:1. A biaxially stretched film may be sequentially stretched in both the MD and TD directions, in either order.

As indicated above, it has been noticed that drawing increases the stiffness of the face 110. For example, the Young's modulus of biaxially oriented PET is as high as 4 GPa, while the Youngs modulus of unoriented PET is from 2 GPa to 2.7 GPa. Thus, when for the separation of the label 102 from the web (100, 101), at least part of the film 100 (such as the face 110) is oriented in at least one direction. Preferably the face 110 is oriented in at least one direction. The face 110 may be oriented in only one direction. Preferably the face 110 is oriented in at least the machine direction. The face 110 may be oriented in only in the machine direction

This is particularly true, when a roller 200, such as an anvil roller, is used to separate the label 102 from the remaining web 101 (cf. FIGS. 4a to 4d). The surface of the anvil roller is, by the nature of the roller, curved. Preferably, in the method or use, the face 110 is oriented in at least on direction, wherein the direction is arranged parallel with the surface of the anvil roller, in at least at the contact point between the film 100 and the anvil roller 200, and perpendicular to the axis of rotation of the anvil roller. E.g. With reference to FIG. 4a, at least a direction of orientation of the film 100 is parallel to the direction Sx, wherein the direction Sx is parallel with the surface of the anvil roller 200, at the contact point of the anvil roller 200 and the film 100, and perpendicular to the axis of rotation of the anvil roller 200 (Sz, which is perpendicular to the plane of the FIG. 4a, not shown in the FIG. 4a). Preferably, the film 100 is oriented in at least the machine direction. Preferably, the film is arranged in relation to the anvil roller 200 in such a way that the machine direction is perpendicular to the axis of rotation of the roller 200, at the contact point between the film 100 and the roller 200. The film may be oriented only in the machine direction.

The heat activatable layer 120 may provide for some flexural stiffness for the label 102, and may provide form more stiffness in the unactivated state. Therefore, and embodiment (FIG. 4c) comprises
cutting a label 102 from a web 100,
separating the cut label 102 from the web 100 or the remaining web 101, and thereafter
heating the cut label.

In this way, the stiffness of the label if higher at the time of separating the label from the web. Moreover, in addition to the activatable material, the stiffness of the face may be temperature dependent, and in general higher at low temperatures. This even further points out the technical effect of this order of the process steps. Still further, recycling of the remaining web 101 may be easier, if the remaining web 101 does not comprise heat activated adhesive 122, but comprises heat activatable adhesive 120. This is the case, when only a cut label 102 is heated.

The thermally activatable layer 120 has the functional properties as discussed above. The possibilities for the material of the second layer include adhesives based on ethyl-vinyl-acetate (EVA). Thus, in an embodiment, the second layer 120 comprises ethyl-vinyl-acetate (EVA). However, it has been noticed that EVA based adhesives may have reasonable low adhesion to polymer substrates or glass substrates (such as the bodies 400). Therefore, also other types of adhesives may be used in the second layer. Moreover, activators may be used to improve the adhesion to a substrate. The composition of the activator may be selected according to the material of the substrate. However, EVA based adhesives were seen to adhere well onto parcels (bodies) having paper or cardboard on their surface.

Due to the polymer composition of the layers 110, 120, the surfaces 115, 125, may be apolar and may have a low surface tension, which is bas for printing, as discussed above. Low surface tension may lead to poor retaining capability of printing ink or other coating material, which may be applied to the surface 115, 125. Thus, at least one of the surfaces 115, 125 may be surface treated by e.g. by flame treatment, corona treatment, plasma treatment in order to enhance the surface tension of the surface and to enhance, for example, adhesion of the printed graphics.

The treatment increasing the surface tension may not be permanent, and the level of surface tension may decrease from the obtained treatment level as a function of time. The treatment may later be repeated to restore the level of surface tension obtained in a previous treatment.

Referring to FIG. 1a, in an embodiment, the thickness H₁ of the first layer 110 is from 12 μm to 130 μm; preferably from 25 μm to 60 μm. In an embodiment, the thickness H₂ of the second layer 120 is from 5 μm to 50 μm; preferably from 20 μm to 30 μm. In an embodiment the thickness H of the film 100 is from 12 μm to 130 μm, preferably from 45 μm to 90 μm.

As discussed, preferably the first layer comprises material that is heat resistant to at least some temperatures above the activation temperature Ta.

In an embodiment, the first layer 110 comprises only materials that do not melt below the activation temperature Ta.

In an embodiment, the first layer 110 comprises material or materials having a glass transition temperature less than the activation temperature. For example the first layer may comprise polymer having a low glass transition temperature (less than Ta) and further comprise metal, which do not have a glass transition temperature at all. In an embodiment, the first layer consists of material or materials (i) having a glass transition temperature less than the activation temperature and/or (ii) not having a glass transition temperature.

In an embodiment, the first layer 110 consists of material or materials having a glass transition temperature less than the activation temperature.

Moreover, in an embodiment, the dimensional stability of the film is good. Some films of this kind are known to shrink, when heat is applied. In an embodiment, the shrinkage of the film 100, at the activation temperature Ta, is at most 5%, preferably at most 3%, more preferably at most 1%. The shrinkage is here defined as the relative difference (L0−L(Ta))/L0, wherein L0 is the length (in a direction) of the films before said thermal activation (i.e. an initial length), and L(Ta) is the length of the film having the initial length L0, in the same direction, after thermal treatment at the activation temperature Ta. The temperature before said thermal activation may be e.g. 30° C.

Preferably the film comprises such materials that the optical properties of the film do not change during the activation. This is particularly true, when transparent films are used. In an embodiment, at least one optical property of the film does not irreversibly change at said thermal activation more than 5% in the direction that the clarity of the film reduces. For example, in an example, the irreversible increase of haze is at most 5% at said thermal activation. In case the haze reversibly changes, i.e. changes back when temperature decreases, this does not make the film optically worse. For example, in an example, the irreversible increase of opacity is at most 5% at said thermal activation. Optical properties of the film 100 will be discussed in more detail below.

The film 100 may be opaque, translucent, or transparent. In an opaque film, the absorbance, i.e. transmission coefficient multiplied with the thickness, of at least one of the layers 110, 120 is high for all visible wavelengths. Alternatively, the surface 115 may be reflective and/or scattering, and/or the boundary between the layers 110 and 120 may be reflective and/or scattering.

The opacity of an opaque film may be e.g. at least 70%, preferably at least 75% of at least 80% as measured according to ISO 2471. Optionally, the opacity is at most 100%, at most 99%, or at most 95%.

The opaque film may be e.g. white. In such a case, the face 110 may comprise white pigment, such as titanium oxide, TiO₂, calcium carbonate (CaCO₃), and/or alumina (Al₂O₃). Such white opaque films may be printed, e.g. with the markings 130 on the first surface 115, to comprise other colors. The face 110 of an opaque film may comprise a transparent sub-layer and an opaque sub-layer, such as metal foil or paper. Thus, the first layer 110 of an opaque film may comprise paper and/or metal.

Gloss is a measure of the proportion of light that has a specular reflection from the surface, it is defined by the ASTM standards C346, D523, C584 and D2457 as “angular selectivity of reflectance, involving surface-reflected light, responsible for the degree to which reflected highlights or images of objects may be seen as superimposed on a surface”. A surface such as a mirror has a high gloss, where a surface such as chalk has less because the light reflected is diffused.

Such white opaque film may be a glossy film or a matt film. Typically, the gloss of a glossy white film is at least 60%, at least 70% and preferably at least 75%. The gloss may be measured at an angle of 60 degrees; at least for values at most 70%. For higher values, a smaller angle, such as 45 degrees may be used. Typically, the gloss of a matt white film is at most 15%, at most 10% and preferably at most 7%. For opaque films, the relevant gloss is measured from the first surface 115 comprised by the face 110.

A translucent film passes some light, but typically after multiple internal scattering events. Thus, a clear image is not visibly through a translucent film 100. A translucent film may also be characterized as a poorly transparent film, having reasonable low transparency, and relatively large haze.

A transparent film 100 allows light to pass the film without internal scattering. Thus, a clear image is visible through the film 100. The clarity of the image, as viewed through a film, may be described with a value of haze. A transparent film may be colourful, e.g. arranged to pass light having a special wavelength. In this application, a transparent film is typically transparent at all visible wavelengths. Thus the label 102 itself on the body 400 is invisible or barely visible to the naked eye.

A transparent film is not opaque. As for a definition, in terms of opacity, the opacity of a transparent film is less than 20%, typically much less, such as at most 10%, at most 5% or at most 1%. A transparent film also has a reasonably low haze, as will be discussed.

The film 100 may be transparent. In particular, the optical properties of a transparent face may be described with at least one of clarity, haze and gloss. Haze describes scattering of light by some medium or the surface(s) thereof, which results into cloudy appearance, and poorer clarity of objects when viewing through that. A low haze value therefore means clearer transparency. Haze (value) is defined as the percentage of light that is deflected more than 2.5 degree from the incoming light direction. In principle, the haze can be measured from the first surface 115 or the second surface 125. However, as the first surface 115 is directly visible to a viewer, the haze properties may, in particular, be measured from the first surface 115, comprised by the face 110.

In some embodiments of a transparent film, the haze is from 20 and 35% prior to printing and over-varnishing (e.g. protecting, as will be discussed) of the face 110 of the film 100. However, when used, the film 100 can be printed (on either surface 115, 125) and/or over-varnished (from the face surface 115). The haze of the film, as measured from the (optionally over-vanished) surface 115 of the face may be lower than 10%, preferably lower than 8%, such as at less than 5%, or less than 3%. For example, the haze may be between 0.5% and 8%, between 1% and 6% or between 3% and 5%. The haze can be tested according to standard ASTM D1003.

For transparent films, the gloss may be measured from either the second surface 125 or the first surface 115. However, as the first surface is directly visible to the eye, the gloss of the film, measured from the first surface 115 comprised by the face 110, may be more relevant then the gloss measured from the other side.

The gloss of a transparent film is preferably relatively high. The gloss of a transparent film 100, measured at 45 degrees, from the side of the first surface 115, may be e.g. at least 60%, more typically at least 70%, and preferably at least 75%.

As motivated above, laser cutting is an appealing option for cutting a label 102 out of the film 100. Moreover, optically clear films may be used. However, when the optical clarity of the film become better, less light is absorbed by the film 100. Thus, laser cutting of optically clear films was in some cases problematic.

However, it was surprisingly found that even for visibly clear films, laser cutting could be applied by selecting the wavelength of the cutting laser appropriately. For some visibly clear films, an UV laser was seen to work. For some visibly clear films, an IR laser was seen to work. It is supposed that this bears evidence on the wavelength dependent optical properties of the film. In particular, the absorbance of the layer 110 or the layer 120 may be higher the UV or IR than at the visible.

In an embodiment,
the average absorption coefficient for the first layer and for the visible light is <α₁>_{VIS}, wherein the visible light form a spectrum of wavelength from 360 nm to 750 nm,
for a wavelength λ₁, the absorption coefficient for the first layer α₁(λ₁) is at least 10×<α₁>_{VIS}, wherein the wavelength λ₁ belongs to the infrared or the ultraviolet spectrum, i.e. the wavelength λ₁ is less than 360 nm or more than 750 nm.

Here the average absorption coefficient <α₁>_{VIS} is defined as the average of the absorption coefficient α₁ of the material of the first layer 110, wherein the average is taken over the visible spectrum, i.e. from 360 nm to 750 nm. In the corresponding method, the film may be cut with a laser having the wavelength λ₁. Thus, even if transparent at other wavelengths, the film may be cut using a wavelength from the absorptive spectrum. The corresponding use or method comprises selecting the laser wavelength such that the wavelength belong to an absorptive spectrum of the first layer 110. In particular it was found that an UV laser works well for many plastic materials. Thus, in an embodiment, the α₁(λ₁) is high (in the above sense) for a wavelength corresponding the UV.

In an embodiment,
the average absorption coefficient for the second layer and for the visible light is <α₂>_{VIS}, wherein the visible light form a spectrum of wavelength from 360 nm to 750 nm,
for a wavelength λ₂, the absorption coefficient for the first layer α₂(λ₂) is at least 10×<α₂>_{VIS}, wherein the wavelength λ₂ belongs to the infrared or the ultraviolet spectrum, i.e. the wavelength λ₂ is less than 360 nm or more than 750 nm.

Here the average absorption coefficient <α₂>_{VIS} is defined as the average of the absorption coefficient α₂ of the material of the second layer 120, wherein the average is taken over the visible spectrum, i.e. from 360 nm to 750 nm. In the corresponding method, the film may be cut with a laser having the wavelength λ₂. Thus, even if transparent at other wavelengths, the film may be cut using a wavelength from the absorptive spectrum. The corresponding use or method comprises selecting the laser wavelength such that the wavelength belong to an absorptive spectrum of the first layer 120. In particular it was found that an UV laser works well for many plastic materials. Thus, in an embodiment, the α₂(λ₂) is high (in the above sense) for a wavelength corresponding the UV.

In an embodiment of a use or a method, the laser wavelength is selected such that the wavelength belongs to an absorptive spectrum of the film 100, i.e. the combination of the first and the second layer.

### Details of Labelled Items

As is clear from the discussion, many of the properties of the film 100 is inherited by the labelled item 401. However, some properties of the activatable material of the second layer 120 are changed, when activated to the activated material 122. For technical reasons, the adhesive properties must change. However, the optical properties may also change.

Some embodiments of the labeled item 401 will be reviewed below to show how the various propertied of the film 100 are reflected in the labeled item 401.

An embodiment of a labeled item 401 comprises markings arranged on the surface of the first layer; in between the first layer and the second layer; or in between the second layer and the body. In an embodiment, the surface of the first layer 110 of the item 401 is printable. In an embodiment, the surface of the first layer is has a surface tension from 36 mN/m to 46 mN/m, preferably from 38 mN/m to 44 mN/m, as measured according to the standard ISO 8296.

In an embodiment, the first layer 110 (of the label 102 of the labelled item 401) comprises plastic polymer. In an embodiment, the first layer 110 comprises at least one of polypropylene (PP), polyethylene (PE), a blend consisting of polypropylene (PP) and polyethylene (PP), polyester; and polyvinylchloride (PVC). In an embodiment, the first layer 110 comprises at least one sub-layer that consist of only one polymer material selected from the group of the following five plastics: (1) polypropylene (PP), (2) polyethylene (PE), (3) a blend consisting of polypropylene (PP) and polyethylene (PP), (4) polyester; and (5) polyvinylchloride (PVC). In an embodiment, the first layer 110 consists of only one polymer material selected from the group of the following five plastics: (1) polypropylene (PP), (2) polyethylene (PE), (3) a blend consisting of polypropylene (PP) and polyethylene (PP), (4) polyester; and (5) polyvinylchloride (PVC). In an embodiment, the first layer 110 consists of only one polymer material selected from the group of the following three plastics: (1) polypropylene (PP), (2) a blend consisting of polypropylene (PP) and polyethylene (PP), and (3) polyester. Polyesters include e.g. polyethylene terephthalate.

In an embodiment, the first layer comprises at least one of polyester, such as PET, and polypropylene. In an embodiment, the first layer further comprises metal and/or paper. In an embodiment, the first layer consists of a plastic polymer material, or a mixture of a plastic polymer materials; optionally admixed with a pigment material.

In an embodiment, second layer (of the label 102 of the labelled item 401) comprises ethyl-vinyl-acetate.

In an embodiment, the thickness of the first layer 110 (of the label 102 of the labelled item 401) is from 12 μm to 130 μm; preferably from 25 μm to 60 μm. In an embodiment, the thickness of the second layer 120 (of the label 102 of the labelled item 401) is from 5 μm to 50 μm; preferably from 20 μm to 30 μm.

However, regarding the optical properties of the label 102 as attached to the body 400, the properties can be measured from the label 102 when attached to the body 400, or after the removal of the label 102 from the labelled item 401. Moreover, the optical properties may refer only to the first layer 110 of the label, or to the combination of the second layer 122 (comprising the activated material) and the first layer 110.

In an embodiment, the first layer (of the label 102 of the labelled item 401), is opaque, having the opacity of at least 70%. In an embodiment, the first layer comprises paper and/or metal. In an embodiment, the first layer is glossy, having the gloss of at least 60%; preferably at least 70% or at least 75%. In an embodiment, the first layer is matt, having the gloss of at most 15%; preferably at most 10% or at most 7%.

In an embodiment, the first layer is transparent, having the opacity of at most 20%. For the measurements of the opacity of the first layer, the first layer 110 may have to be removed from the labeled item 401.

In an embodiment, the haze of the first layer 110, when separated from the body 400, is at most 10%; preferably at most 5%, and more preferably at most 3%; optionally at most 15%.

In an embodiment, the gloss of the first layer, when attached to the body 400, is at least 70%. In an embodiment, the gloss of the first layer, when separated from the body, is at least 70%.

In an embodiment, the combination of the first layer and the second layer is transparent and has the opacity of at most 20%. In an embodiment, the haze of the combination of the first layer and the second layer is at most 10%; preferably at most 5%, and more preferably at most 3%; optionally at most 15%. The measurement of one or both of these properties this may require that the body 400 is also transparent and has a relatively low haze. These values may refer to the combination of the first layer 110, the second layer 122, and the part of the body 400 that is labeled with the label. These values may refer to the combination of the first layer 110 and the second layer 122, when separated from the body 400.

In some embodiments, the Young's modulus of the material of the first layer 110 of the label 102 of the labeled item 401 is at most 10 GPa, preferably at most 6 GPa, such as at most 5 GPa, as measured at the temperature 25° C. In some embodiment the Young's modulus of the material of the first layer 110 of the label 102 of the labeled item 401 is at least 0.5 GPa, such as at least 1 GPa or at least 1.3 GPa, as measured at the temperature 25° C.

When the label 102 is cut by laser cutting, some material is melted. Some of the melted material may solidify on the boundary of the label. This material is typically not visible to the naked eye, but can be seen using a microscope. Thus, from the labeled item 401, one can observe whether a laser cutting process was used to cut the label. In an embodiment, the first layer and/or the second layer comprises, on its boundary, markings indicative of laser cutting, such as solidified pieces of melted material of the first and/or the second layer.

The body 400 of the labeled item may comprise at least one of polyethylene (PE), high density polyethylene (HDPE), low density polyethylene (HDPE), polyethylene terephthalate (PET), polyvinyl chloride (PVC), glass, and cardboard.

In an embodiment, the body 400 is a hollow object; whereby the body 400 comprises at least one wall, and
the wall of the body has a corrugated structure.

The corrugated structure improves the strength of the body. Typically a body comprising cardboard has a corrugated structure. Thus, in an embodiment, the corrugated wall of the body comprises cardboard.

In an embodiment, the body 400 is a hollow object; whereby the body 400 comprises at least one wall, and
the body 400 has the shape of a container.

A contained may be e.g. concave. Such containers may be made of plastic materials. In an embodiment, the body 400 comprises plastic, such as polyethylene (PE), high density polyethylene (HDPE), low density polyethylene (LDPE), polyethylene terephthalate (PET), polyvinyl chloride (PVC). In an embodiment, the body 400 consists of plastic material or plastic materials. Examples of such plastic material were given above.

In an embodiment, the body 400 comprises an inlet, wherein the cross sectional area of the inlet is at most half of the cross sectional area (e.g. the maximum cross sectional area when the surface of the body is not uniform) of the body; whereby the body has the shape of a bottle. Such a container or bottle-shaped container may comprise at least one of high density polyethylene (HDPE), or polyethylene terephthalate (PET). Such a container or bottle-shaped container may consist of high density polyethylene (HDPE). Such a container or bottle-shaped container may consist of polyethylene terephthalate (PET).

A container or bottle-shaped container may comprise glass or consist of glass.

In an embodiment, the first layer 110 (of the label 102) is arranged onto the body 400, and the shape of the body 400 is such that the first layer 110 has a curved shape, wherein the shape of the first layer 110 is a bent plane, where the plane is bent only along one axis or several parallels axes. For example a cylindrical body with a uniform diameter has a surface, such that when the label is attached to the surface, the (initially planar) label is bent along one axis. For example, a tubular body, having a constant cross section having the shape of a rounded rectangle, has also such a shape. The parallel bending axes correspond to the rounded edges of the cross section. This has the effect that the label 102 has been smoothly attached to the surface of the body 400. In case the surface would have the shape of a bend plane, having two e.g. perpendicular bending axes, the label would ruck up during labelling. Naturally the surface of the body refers to the part of the surface, onto which the label is attached. Having been attached in the described way, the shape of the first layer 110 corresponds to the shape of that part of the surface of the body 400.

Naturally, the first layer 110 needs not to be bent. In the corresponding embodiment, the first layer 110 is arranged onto the body 400, and the shape of the body is such that the first layer is planar and straight.

The body may be opaque, translucent (i.e. hazy), or transparent. An opaque body may be e.g. a black HDPE bottle. A translucent body may be e.g. a hazy LDPE jug. In an embodiment, the body 400 is transparent. The opacity of a transparent body may be e.g. at most 10% or at most 1%. Preferably, if the body 400 is transparent, the label 102 is also transparent. More precisely, in an embodiment, wherein the body 400 is transparent, the combination of the second layer 122 and the first layer 110 is also transparent. Transparency of the combination may be described by the aforementioned opacity values of the film 100.

Details of the Use and/or the Method

Referring to FIGS. 4a to 4d, a roller 200, such as an anvil roller, may be used to separate the label from the remaining film. In combination with the roller, the means for holding a label 102 from the first layer 110 or from the surface 115 of the first layer 110 can be used to separate the label from the remaining film. The means may comprise a vacuum tool or gripper, such as one of the means described above.

To activate the material of the second layer 120, the method or use comprises heating the film 100 (FIG. 4a) or a cut label 102 (FIG. 4c) to a temperature from 75° C. to 135° C. Preferably to a temperature from 90° C. to 125° C. Preferably the thermal activation is performed rapidly. An embodiment comprises heating the film 100 or a cut label 102 from an initial temperature to a final temperature in a time, wherein the time is less than 0.5 s, preferably less than 100 ms. Evidently, the final temperature is at least the activation temperature Ta. The final temperature may exceed the activation temperature by at least 5° C., 10° C., or 20° C. Heating of the film 100 or the label 102 may be done by using at least one of
electromagnetic radiation, such as infrared (IR) radiation,
convection, e.g. by using a hot heat transfer medium, such as air or steam, and
contact with a hot object, such as a roller, such as the anvil roller.

As discussed above, the film 100 may be e.g. transparent or opaque. The term “opaque” refers, in particular to visible light. In an embodiment, the label is cut by a laser having the wavelength of visible light, i.e. from 360 nm to 750 nm. Preferably, for the wavelength of the laser, the film has a transmittance of at most 99.9% for light having the wavelength of the laser.

Clear films, as discussed above, may have higher absorbance (or correspondingly lower transmittance) in the IR or UV. As for using an IR laser, an embodiment comprises cutting the label by a laser having the wavelength of infrared light, i.e. more than 750 nm. The film 100 that is cut by the laser, may have a transmittance of at most 99.9% for light having the wavelength of the laser. As for using an ultraviolet laser, an embodiment comprises cutting the label by a laser having the wavelength of ultraviolet light, i.e. less than 360 nm. The film 100 that is cut by the laser, may have a transmittance of at most 99.9% for light having the wavelength of the laser.

In the method or use, a continuous or a pulsed laser may be used. The power of a continuous laser is constant in time; whereby the peak radiative intensity of a continuous laser is the constant value. A pulse laser generates light pulses, which have a peak radiative intensity. A sufficiently powerful laser is needed to cut the film, and to cut it fast. However, by the proper selection of materials and wavelengths, the optical power requirements may be brought down. An embodiment comprises forming the cut 140, i.e. cutting the label 102, by a continuous or pulsed laser light beam, wherein the peak radiative intensity of the laser beam is at least 10 MW/m²; preferably at least 100 MW/m² or at least 500 MW/m². The lowest of these values can be achieved e.g. using a laser having the (peak) radiative power of 100 W, wherein the area of the laser beam is 10 mm². Increasing the power or decreasing the beam size increases the radiative intensity. A reasonably intense laser enables reasonably fast cutting, and thereby reasonably fast manufacturing process.

In order to improve the adhesion between the activated material 122 of the label 102, the body 400 may be pre-heated before attaching the label 102 to the body 400. This is depicted in FIG. 4a, wherein a second heater 510 is arranged to heat the body 400. As is evident, such a second heater could be arranged in the other embodiments, too. Thus, an embodiment of the use or the method comprises pre-heating the body 400 before attaching the second layer 122 of the label 102 onto the body 400. An embodiment comprises pre-heating the body to a temperature of at least 50° C. Pre-heating of the body 400 may be done by using at least one of
electromagnetic radiation, such as infrared (IR) radiation,
convection, e.g. by using a hot heat transfer medium, such as air or steam, and
contact with a hot object, such as the tool 300.

The attachment of the label 102 to the body 400 is done preferably soon after the adhesive has been activated. Using the previously defined four times, preferably the fourth time (that of attaching the label) is at most 5 s later than the first time (that of activating the adhesive), i.e. t₄<t₁+5 s. Thus, even if the activated adhesive stays active for a relatively short period of time (say a bit more than 5 s), the attachment would be possible. Preferably, t₄<t₁+3. Furthermore, quite generally a rapid manufacturing process is preferred over a slow one. Thus, preferably the attachment of the label 102 to the body 400 is also done soon after the laser cutting. The time difference may again be e.g. at most 5 s. Using the previously defined four times, preferably the fourth time is at most 5 s later than the second time (that of cutting the film), i.e. t₄<t₂+5 s. Preferably t₄<t₂+3 s. Moreover, to have a fast process, preferably the heating and the cutting are separated by at most 5 s in the temporal sense. Thus, in an embodiment, the absolute value of the difference of the first time and the second time is at most 5 s, i.e. abs(t₂−t₁)<5 s. Preferably abs(t₂−t₁)<3 s.

This kind of rapid process can be realized e.g. by using an apparatus to heat the film 100 or the label 102, and using the same apparatus to laser cut the label 102 from the film 100. Preferably the same apparatus is used also to attach the label 102 to the body 400. Naturally, the same apparatus can be used to separate the label 102 from the web (100,101).

These issues can also be described is spatial terms, using the four locations r₁ . . . r₄ as defined above. Preferably the heat activation and the laser cutting are performed close to each other. In the corresponding use or method, the distance between the first location r₁ and the second location r₂, |r₁−r₂|, is at most 3 meters; preferably at most 2 meters; more preferably at most 1 meter. It is here noted that the location, in general, is a three dimensional vector, and the function |x| is the norm (specifically the Euclidean norm) of the vector x.

Preferably, the distance from the location wherein the label is attached to the location of laser cutting or to the location of heating, whichever is closer, is at most 3 m. Using the aforementioned locations, in an embodiment, the shorter of the two distances, the first distance from the first location to the fourth location, and the second distance from the second location to the fourth location, i.e. min(|r₁−r₄|, |r₂−r₄|), is at most 3 m. Preferably min(|r₁−r₄|,|r₂−r₄|), is at most 2 m or at most 1 m. Moreover, preferably the longer of the two distances, the first distance from the first location to the fourth location, and the second distance from the second location to the fourth location, i.e. max(|r₁−r₄|,|r₂−r₄|), is at most 5 m. Preferably max(|r₁−r₄|,|r₂−r₄|), is at most 3 m.

FIG. 5 shows yet another embodiment of the use or the method. In the corresponding use or method, a wide film 100 is supplied on a roll. The wide film has a length in the direction “DIR100” and a width W (in the transverse direction), as indicated in the figure. In the embodiment the film 100 is divided, using the blades 109, to at least a first part 100a and a second part 100b in the direction of the width of the film. Moreover, the labels 102 are laser cut from the parts 100a and 100b, heated, and attached to bodies, as disclosed above. In FIG. 5, the film 100 is divided also to a further third part 100c.

The parts 100a, 100b, of the film 100 may each be treated in a separate labelling unit, such as the labelling units 900a and 900b. Correspondingly the first part 100a is used in a first labelling device 900a and the second part 100b is used in a second labelling device 900b. As indicated, also a third labelling device 900c can be used. Correspondingly, the parts 100a, 100b, 100c of the film 100 are fed to the devices 900a, 900b, 900c in the directions DIR100a, DIR 100b, and DIR 100c, respectively. The labelling devices 900a, 900b, 900c may comprise the features of the labelling device 900, as detailed above and in FIGS. 4a to 4d.

The following examples summarize some embodiments:

1.1. A film suitable for thermal activation and laser cutting, the film having
a length, a width, and a thickness, wherein the thickness is smaller than the length and the width, the film comprising
a first surface and an opposite second surface,
a first layer having the length and the width, and comprising the first surface,
a second layer arranged onto the first layer and comprising the second surface, wherein
the second layer comprises thermally activatable material such that
   in a thermal activation process, wherein the temperature of the thermally activatable material rises above an activation temperature Ta, the adhesion properties of the material change such that
   before said thermal activation, the material of the second layer is solid and non-sticky, and
   after said thermal activation, the material of the second layer is viscous and forms an active adhesive; wherein
the activation temperature Ta, is from 75° C. to 135° C.;
the first layer comprises material that is resistant to some temperatures higher than Ta, and
the material of the first layer, the material of the second layer, or the film comprising the first and the second layers is capable of absorbing electromagnetic energy, whereby the film is suitable for laser cutting.
   1.2. The film of example 1.1, comprising
markings arranged on the first surface,
markings arranged on the second surface, or
markings arranged in between the first layer and the second layer.
   1.3. The film of example 1.1 or 1.2, wherein
at least one of the first surface and the second surface is printable.
   1.4. The film of example 1.3, wherein
the surface or surfaces that is or are printable has or have a surface tension from 36 mN/m to 46 mN/m, preferably from 38 mN/m to 44 mN/m, as measured according to the standard ISO 8296.
   1.5. The film of any of the examples 1.1 to 1.4, wherein
the first layer comprises plastic polymer.
   1.6. The film of the example 1.5, wherein
the first layer comprises at least one of polypropylene (PP), polyethylene (PE), a blend consisting of polypropylene (PP) and polyethylene (PP), polyester, and polyvinylchloride (PVC).
   1.7. The film of the example 1.6, wherein
the first layer comprises one of polypropylene (PP); a blend consisting of polypropylene (PP) and polyethylene (PP); and polyester (such as polyethylene terephthalate, PET).
   1.8. The film of any the examples 1.7, wherein
the first layer further comprises metal and/or paper and/or
the first layer comprises a layer or a sub-layer that consists of (i) a plastic polymer material, (ii) a plastic polymer material mixed with at least one pigment, such as as titanium oxide, TiO₂, calcium carbonate (CaCO₃), and/or alumina (Al₂O₃), (iii) a mixture of plastic polymer materials, or (iv) a mixture of plastic polymer materials and at least one pigment, such as as titanium oxide (TiO₂), calcium carbonate (CaCO₃), and/or alumina (Al₂O₃); preferably the plastic material is one of polypropylene (PP); a blend consisting of polypropylene (PP) and polyethylene (PP); and polyester (such as polyethylene terephthalate, PET).
   1.9. The film of any of the examples 1.1 to 1.7, wherein
the first layer consists of (i) a plastic polymer material, (ii) a plastic polymer material mixed with at least one pigment, such as as titanium oxide, TiO₂, calcium carbonate (CaCO₃), and/or alumina (Al₂O₃), (iii) a mixture of plastic polymer materials, or (iv) a mixture of plastic polymer materials and at least one pigment, such as as titanium oxide, TiO₂, calcium carbonate (CaCO₃), and/or alumina (Al₂O₃).
   1.10 The film of the example 1.9, wherein
the first layer comprises polymer material selected from the group of the following five plastics: (1) polypropylene (PP), (2) polyethylene (PE), (3) a blend consisting of polypropylene (PP) and polyethylene (PP), (4) polyester; and (5) polyvinylchloride (PVC).
   1.11 The film of the example 1.10, wherein
the first layer comprises one of polypropylene (PP); a blend consisting of polypropylene (PP) and polyethylene (PP); and polyester (such as polyethylene terephthalate, PET).
   1.12. The film of any of the examples 1.1 to 1.11, wherein
the second layer comprises ethyl-vinyl-acetate.
   1.13. The film of any of the examples 1.1 to 1.12, wherein
the thickness of the first layer is from 12 μm to 130 μm; preferably from 25 μm to 60 μm.
   1.14. The film of any of the examples 1.1 to 1.13, wherein
the thickness of the second layer is from 5 μm to 50 μm; preferably from 20 μm to 30 μm.
   1.15. The film of any of the examples 1.1 to 1.14, wherein
the film is opaque, having the opacity of at least 70%.
   1.16. The film of the example 1.15, wherein
the first layer comprises paper and/or metal.
   1.17. The film of the example 1.15, wherein
the film is glossy, having the gloss of at least 60%; preferably at least 70% or at least 75%.
   1.18. The film of the example 1.15, wherein
the film is matt, having the gloss of at most 15%; preferably at most 10% or at most 7%.
   1.19. The film of any of the examples 1.1 to 1.14, wherein
the film is transparent, having the opacity of at most 20%.
   1.20. The film of the example 1.19, wherein
the haze of the film is at most 10%; preferably at most 5%, and more preferably at most 3%; optionally at least 0.1%.
   1.21. The film of the example 1.19 or 1.20, wherein
the gloss of the film is at least 70%.
   1.22. The film of any of the examples 1.1 to 1.21, wherein
the Young's modulus of the material of the first layer is at least 0.5 GPa, optionally at most 10 GPa.
   1.23. The film of any of the examples 1.1 to 1.22, wherein
after said thermal activation, the material of the second layer is viscous and forms an active adhesive even if the temperature of the material of the second layer drops below the activation temperature Ta; optionally also when the temperature of the material of the second layer drops below the activation temperature Ta by at least 10° C.
   1.24. The film of any of the examples 1.1 to 1.23, wherein
the second layer comprises material that stays, after said thermal activation, in the tacky adhesive form for at least 2 seconds, preferably at least 5 seconds; optionally at most seven days.
   1.25. The film of any of the examples 1.1 to 1.24, wherein
the shrinkage of the film, at the activation temperature Ta, is at most 5%, preferably at most 3%, more preferably at most 1%.
   1.26. The film of any of the examples 1.1 to 1.25, wherein
the first layer consists of material or materials (i) having a glass transition temperature less than the activation temperature and/or (ii) not having a glass transition temperature.
   1.27. The film of any of the examples 1.1 to 1.26, wherein
at least one optical property, such as haze or opacity, of the film does not irreversibly change at said thermal activation more than 5% in the direction that the optical clarity of the film reduces.
   1.28. The film of any of the examples 1.1 to 1.27, wherein
the average absorption coefficient for the first layer and for the visible light is <α₁>_{VIS}, wherein the visible light form a spectrum of wavelength from 360 nm to 750 nm,
for a wavelength λ₁, the absorption coefficient for the first layer α₁(λ₁) is at least 10×<α₁>_{VIS}, wherein the wavelength λ₁ belongs to the infrared or the ultraviolet spectrum, i.e. the wavelength λ₁ is less than 360 nm or more than 750 nm.
   1.29. The film of any of the examples 1.1 to 1.28, wherein
the average absorption coefficient for the second layer and for the visible light is <α₂>_{VIS}, wherein the visible light form a spectrum of wavelength from 360 nm to 750 nm,
for a wavelength λ₂, the absorption coefficient for the first layer α₂(λ₂) is at least 10×<α₂>_{VIS}, wherein the wavelength λ₂ belongs to the infrared or the ultraviolet spectrum, i.e. the wavelength λ₂ is less than 360 nm or more than 750 nm.
   1.30. The film of any of the examples 1.1 to 1.29,
being oriented in at least one direction.
   1.31. The film of the example 1.30,
being oriented in at least the machine direction.
   1.32. The film of the example 1.31,
being biaxially oriented.
   1.33. The film of the example 1.30 or 1.31,
being monoaxially oriented in the machine direction.
   1.34. The film of any of the examples 1.1 or 1.33,
having the flexural stiffness of at least 20 μm; optionally at most 2000 μm.
   2.1. A labelled item, the item comprising
a body,
a first layer of first material, and
a second layer of second material, wherein
the second layer is arranged in between the body and the first layer,
the size of the area of body that is covered by the second layer is A_{b2},
the size of the area of second layer that is covered by the first layer is A₂₁,
the ratio the these areas, A_{b2}/A₂₁, is between 0.95 and 1.05,
the first layer comprises material that is resistant to temperatures higher than 90° C.,
the second layer comprises thermally activated material, wherein the thermally activated material has been thermally activated, and
the first layer and/or the second layer comprises material capable of absorbing electromagnetic energy.
   2.2. The labelled item of example 2.1, comprising
markings arranged on the surface of the first layer; in between the first layer and the second layer; or in between the second layer and the body.
   2.3. The labelled item of example 2.1 or 2.2, wherein
the surface of the first layer is printable.
   2.4. The labelled item of any of the examples 2.1 to 2.3, wherein
the surface of the first layer is has a surface tension from 36 mN/m to 46 mN/m, preferably from 38 mN/m to 44 mN/m, as measured according to the standard ISO 8296.
   2.5. The labelled item of any of the examples 2.1 to 2.4
the first layer comprises plastic polymer.
   2.6. The labelled item of the example 2.5, wherein
the first layer comprises at least one of polypropylene (PP), polyethylene (PE), a blend consisting of polypropylene (PP) and polyethylene (PP), polyester, and polyvinylchloride (PVC); preferably the first layer comprises at least one of polypropylene (PP), a blend consisting of polypropylene (PP) and polyethylene (PP), and polyester.
   2.7. The labelled item of the example 2.6, wherein
the first layer further comprises metal and/or paper.
   2.8. The labelled item of any of the examples 2.1 to 2.6
the first layer consists of (i) a plastic polymer material, (ii) a plastic polymer material mixed with at least one pigment, such as as titanium oxide, TiO₂, calcium carbonate (CaCO₃), and/or alumina (Al₂O₃), (iii) a mixture of plastic polymer materials, or (iv) a mixture of plastic polymer materials and at least one pigment, such as as titanium oxide, TiO₂, calcium carbonate (CaCO₃), and/or alumina (Al₂O₃); preferably the polymer material(s) is/are selected from the group comprising polypropylene (PP), polyethylene (PE), a blend consisting of polypropylene (PP) and polyethylene (PP), polyester, and polyvinylchloride (PVC).
   2.9. The labelled item of any of the examples 2.1 to 2.6, wherein
the first layer comprises a layer or a sub-layer that consists of (i) a plastic polymer material, (ii) a plastic polymer material mixed with at least one pigment, such as as titanium oxide, TiO₂, calcium carbonate (CaCO₃), and/or alumina (Al₂O₃), (iii) a mixture of plastic polymer materials, or (iv) a mixture of plastic polymer materials and at least one pigment, such as as titanium oxide, TiO₂, calcium carbonate (CaCO₃), and/or alumina (Al₂O₃); preferably the polymer material(s) is/are selected from the group comprising polypropylene (PP), polyethylene (PE), a blend consisting of polypropylene (PP) and polyethylene (PP), polyester, and polyvinylchloride (PVC).
   2.10. The labelled item of any of the examples 2.1 to 2.9, wherein
the second layer comprises ethyl-vinyl-acetate.
   2.11. The labelled item of any of the examples 2.1 to 2.10, wherein
the thickness of the first layer is from 12 μm to 130 μm; preferably from 25 μm to 60 μm.
   2.12. The labelled item of any of the examples 2.1 to 2.11, wherein
the thickness of the second layer is from 5 μm to 50 μm; preferably from 20 μm to 30 μm.
   2.13. The labelled item of any of the examples 2.1 to 2.12, wherein
the first layer is opaque having the opacity of at least 70%.
   2.14. The labelled item of the example 2.13, wherein
the first layer comprises paper and/or metal.
   2.15. The labelled item of the example 2.13 or 2.14, wherein
the first layer is glossy, having the gloss of at least 60%; preferably at least 70% or at least 75%.
   2.16. The labelled item of the example 2.13 or 2.14, wherein
the first layer is matt, having the gloss of at most 15%; preferably at most 10% or at most 7%.
   2.17. The labelled item of any of the examples 2.1 to 2.12, wherein
the first layer is transparent, having the opacity of at most 20%.
   2.18. The labelled item of the example 2.17, wherein
the haze of the first layer, when separated from the body, is at most 10%; preferably at most 5%, and more preferably at most 3%; optionally at most 15%.
   2.19. The labelled item of the example 2.17 or 2.18, wherein
the gloss of the first layer, when attached to the body, is at least 70%.
   2.20. The labelled item of any of the examples 2.17 to 2.19, wherein
the combination of the first layer and the second layer is transparent and has the opacity of at most 20%.
   2.21. The labelled item of any of the examples 2.17 to 2.20, wherein
the haze of the combination of the first layer and the second layer is at most 10%; preferably at most 5%, and more preferably at most 3%; optionally at most 15%.
   2.22. The labelled item of the example 2.17 or 2.21, wherein
the gloss of the first layer, when separated from the body, is at least 70%.
   2.23. The labelled item of any of the examples 2.1 to 2.22, wherein
the Young's modulus of the material of the first layer is at least 0.5 GPa, optionally at most 10 GPa.
   2.24. The labeled item of any of the examples 2.1 to 2.23, wherein the first layer and/or the second layer comprises, on its boundary,
markings indicative of laser cutting, such as solidified pieces of melted material of the first and/or the second layer.
   2.25. The labelled item of any of the examples 2.1 to 2.24, wherein
the body comprises at least one of polyethylene (PE), high density polyethylene (HDPE), low density polyethylene (LDPE), polyethylene terephthalate (PET), polyvinyl chloride (PVC), glass, and cardboard.
   2.26. The labelled item of any of the examples 2.1 to 2.25, wherein
the body is a hollow object; whereby the body comprises at least one wall, and
the wall of the body has a corrugated structure; and
optionally, the wall of the body comprises cardboard.
   2.27. The labelled item of any of the examples 2.1 to 2.26, wherein
the body is a hollow object; whereby the body comprises at least one wall, and
the body has the shape of a container; and
optionally, the body comprises plastic, such as polyethylene (PE), high density polyethylene (HDPE), low density polyethylene (LDPE), polyethylene terephthalate (PET), polyvinyl chloride (PVC).
   2.28. The labelled item of any of the examples 2.1 to 2.27, wherein
the body comprises an inlet, wherein the cross sectional area of the inlet is at most half of the cross sectional area of the body; whereby
the body has the shape of a bottle.
   2.29. The labelled item of the example 2.28, wherein
the body comprises high density polyethylene (HDPE), or polyethylene terephthalate (PET).
   2.30. The labelled item of the example 2.28, wherein
the body comprises glass.
   2.31. The labelled item of any of the examples 2.1 to 2.30, wherein
the first layer is arranged onto the body, and the shape of the body is such that
the first layer has a curved shape, wherein
the shape of the first layer is a bent plane, where the plane is bent only along one axis or several parallels axes.
   2.32. The labelled item of any of the examples 2.1 to 2.30, wherein
the first layer is arranged onto the body, and the shape of the body is such that
the first layer is planar and straight.
   2.33. The labelled item of any of the examples 2.1 to 2.32, wherein
the body is transparent, having the opacity of at most 10%.
   2.34. The labelled item of the examples 2.33, wherein
the combination of the second layer and the first layer is transparent.
   2.35. The labelled item of the any of the examples 2.1 to 2.34, wherein
the first layer is oriented in at least one direction.
   2.36. The labelled item of the example 2.35, wherein
the first layer is biaxially oriented.
   2.37. The labelled item of the example 2.35, wherein
the first layer is monoaxially oriented in the machine direction.
   2.38. The labelled item of any of the examples 2.1 or 2.37, wherein
the flexural stiffness of the first layer is at least 20 μNm; optionally at most 2000 μNm.
   3.1. Use of the film of any of the examples 1.1 to 1.34 the use comprising
heating the film or a cut label to activate the material of the second layer,
cutting, by laser, a label from the film, whereby the label comprises a first layer and a second layer these layer having been parts of the layers of the film; and
attaching the second layer of the label onto a body.
   3.2. A method for labelling a body to form a labelled item, the method comprising
providing a film suitable for thermal activation and laser cutting, such as the film of any of the examples 1.1 to 1.34, the film having
   a length, a width, and a thickness, wherein the thickness is smaller than the length and the width, and the film comprising
   a first surface and an opposite second surface,
   a first layer having the length and the width and comprising the first surface
   a second layer arranged onto the first layer and comprising the second surface, wherein
   the second layer comprises thermally activatable material such that
      in a thermal activation, wherein the temperature of the thermally activatable material rises above an activation temperature Ta, the adhesion properties of the material change such that
      before said thermal activation, the material of the second layer is solid and non-sticky, and
      after said thermal activation, the material of the second layer is viscous and forms an active adhesive; wherein
   the activation temperature Ta, is from 75° C. to 135° C.;
   the first layer comprises material that is resistant to temperatures higher than Ta, and
   the first layer and/or the second layer comprises material capable of absorbing electromagnetic energy, whereby the film is suitable for laser cutting; and
heating the film or a cut label to activate the material of the second layer,
cutting, by laser, a label from the film, whereby the label comprises a first layer and a second layer these layers having been parts of the layers of the film; and
attaching the second layer of the label onto a body.
   3.3. The use or method of the example 3.1 or 3.2, comprising
separating the label from the remaining film.
   3.4. The use or method of the example 3.3, comprising
using a roller and a means for holding a label to separate the label from the remaining film.
   3.5. The use or method of any of the examples 3.1 or 3.4, comprising
heating the film or a cut label to a temperature from 75° C. to 135° C.; preferably from 90° C. to 125° C.
   3.6. The use or method of any of the examples 3.1 to 3.5, comprising
heating the film or a cut label from an initial temperature to a final temperature in a time, wherein the time is less than 0.5 s, preferably less than 100 ms.
   3.7. The use or method of any of the examples 3.1 to 3.6, comprising heating the film or a cut label by using at least one of
electromagnetic radiation, such as infrared (IR) radiation,
convection, e.g. by using a hot heat transfer medium, such as air or steam, and
contact with a hot object, such as a roller.
   3.8. The use or method of any of the examples 3.1 to 3.7, comprising
cutting the label by a laser having the wavelength of visible light, i.e. from 360 nm to 750 nm.
   3.9. The use or method of the example 3.8, wherein
the film has a transmittance of at most 99.9% for light having the wavelength of the laser.
   3.10. The use or method of any of the examples 3.1 to 3.7, comprising
cutting the label by a laser having the wavelength of infrared light, i.e. more than 750 nm.
   3.11. The use or method of the example 3.10, wherein
the film has a transmittance of at most 99.9% for light having the wavelength of the laser.
   3.12. The use or method of any of the examples 3.1 to 3.7, comprising
cutting the label by a laser having the wavelength of ultra violet light, i.e. less than 360 nm.
   3.13. The use or method of the example 3.12, wherein
the film has a transmittance of at most 99.9% for light having the wavelength of the laser.
   3.14. The use or method of any of the examples 3.1 to 3.13, comprising
cutting the label by a continuous or pulsed laser light beam, wherein
the peak radiative intensity of the beam is at least 10 MW/m²;
optionally, the radiative power of the laser may be at least 100 W.
   3.15. The use or method of the example 3.14, wherein
the thickness of the film is from 12 μm to 130 μm, preferably from 45 μm to 90 μm.
   3.16. The use or method of any of the examples 3.1 to 3.14, comprising
pre-heating the body before attaching the second layer of the label onto the body.
   3.17. The use or method of the example 3.16, comprising
pre-heating the body to a temperature of at least 50° C.
   3.18. The use or method of any of the examples 3.1 to 3.17, comprising
at a first time t₁, heating the film to activate the material of the second layer and
at a second time t₂, cutting, by laser, a label from the film; and
at a fourth time t₄, attaching the second layer of the label onto a body; wherein
(i) fourth time is later than the later of the first time and the second time, i.e. t₄>max(t₁,t₂); and
(ii,a) t₁ is less than t₂; (ii,b) t₁ is greater than t₂; or (ii,c) t₁ is equal to t₂.
   3.19. The use or method of the example 3.18, wherein
the fourth time is at most 5 s later than the first time, i.e. t₄<t₁+5 s;
optionally the fourth time is also at most 5 s later than the second time, i.e. t₄<t₂+5 s.
   3.20. The use or method of the example 3.18 or 3.19, wherein
the absolute value of the difference of the first time and the second time is at most 5 s, i.e. abs(t₂−t₁)<5 s.
   3.21. The use or method of any of the examples 3.1 to 3.20, comprising
using an apparatus to heat the film or the label, and
using the same apparatus to laser cut the label.
   3.22. The use or method of the example 3.21, comprising
using the same apparatus to attach the label to the body.
   3.23. The use or method of any of the examples 3.1 to 3.22, comprising
in a first location r₁, heating the film or the label to activate the material of the second layer and
in a second location r₂, cutting, by laser, a label from the film; wherein
the distance between the first location r₁ and the second location r₂, |r₁−r₂|, is at most 3 meters.
   3.24. The use or method of any of the examples 3.1 to 3.23, comprising
in a first location r₁, heating the film or the label to activate the material of the second layer,
in a second location r₂, cutting, by laser, a label from the film,
in a fourth location r₄, attaching the second layer of the label onto a body; wherein
the shorter of the two distances, the first distance from the first location to the fourth location, and the second distance from the second location to the fourth location, i.e. min(|r₁−r₄|,|r₂−r₄|), is at most 3 m.
   3.25. The use or method of any of the examples 3.1 to 3.24, comprising
in a first location r₁, heating the film or the label to activate the material of the second layer,
in a second location r₂, cutting, by laser, a label from the film,
in a fourth location r₄, attaching the second layer of the label onto a body; wherein
the longer of the two distances, the first distance from the first location to the fourth location, and the second distance from the second location to the fourth location, i.e. max(|r₁−r₄|,|r₂−r₄|), is at most 5 m.
   3.26. The use or method of any of the examples 3.1 to 3.25, wherein
the film has a length L and a width W such that the length is greater than the width, the use or the method comprising
dividing the film to at least a first part and a second part in the direction of the width of the film, and
laser cutting labels from the first part and the second part.
   3.27. The use or method of the example 3.26, wherein
the first part is used in a first labelling device and
the second part is used in a second labelling device.
   3.28 The use or the method of any of the example 3.1 to 3.27, wherein
the film is oriented in at least one direction of orientation.
   3.29 The use or the method of the example 3.28, comprising
using a roller to separate the label from the remaining film, such that
the direction of orientation is arranged perpendicular to the axis of rotation of the roller.
   3.30 The use or the method of the example 3.29, wherein
the film is biaxially oriented, and
the machine direction or the transverse direction is arranged perpendicular to the axis of rotation of the roller.
   3.31 The use or the method of the example 3.29, wherein
the film is monoaxially oriented in the machine direction, and
the machine direction is arranged perpendicular to the axis of rotation of the roller.
   3.32. The use or the method of the example 3.29, comprising
cutting a label from a web comprising the film,
separating the cut label from the web or the remaining web, and thereafter
heating the cut label.

We claim:

1. A film suitable for thermal activation and laser cutting, the film having a length, a width, and a thickness, wherein the thickness is smaller than the length and the width, the film comprising:
a first surface and an opposite second surface;
a first layer having the length and the width, and comprising the first surface; and
a second layer arranged onto the first layer and comprising the second surface, wherein
the second layer comprises thermally activatable material such that
in a thermal activation process, wherein the temperature of the thermally activatable material rises above an activation temperature Ta, the adhesion properties of the material change such that
before said thermal activation, the material of the second layer is solid and non-sticky, and
after said thermal activation, the material of the second layer is viscous and forms an active adhesive; wherein
the activation temperature Ta, is from 75° C. to 135° C.,
the first layer comprises material that is resistant to some temperatures higher than Ta, and
the material of the first layer, the material of the second layer, or the film comprising the first and the second layer is capable of absorbing electromagnetic energy, whereby the film is suitable for laser cutting.

2. The film according to claim 1, wherein
after said thermal activation, the material of the second layer is viscous and forms an active adhesive even if the temperature of the material of the second layer drops below the activation temperature Ta; optionally also when the temperature of the material of the second layer drops below the activation temperature Ta by at least 10° C.

3. The film according to claim 1, wherein
at least one of the first surface and the second surface is printable, and
the surface or surfaces that is or are printable has or have a surface tension from 36 mN/m to 46 mN/m, as measured according to the standard ISO 8296.

4. The film according to claim 3, wherein
the surface or surfaces that is or are printable has or have a surface tension from 38 mN/m to 44 mN/m.

5. The film according to claim 1, wherein
the first layer comprises plastic polymer.

6. The film according to claim 5, wherein
the first layer comprises one of polypropylene, polyethylene, a blend consisting of polypropylene and polyethylene, polyester, and polyvinylchloride.

7. The film according to claim 5, wherein
the first layer comprises a layer or a sub-layer that consists one of polypropylene, a blend consisting of polypropylene and polyethylene, and polyester, each material optionally mixed with at least one pigment.

8. The film according to claim 7, wherein the at least one pigment comprises at least one of titanium oxide, calcium carbonate or alumina.

9. The film according to claim 1, wherein
the film is opaque, having the opacity of at least 70%.

10. The film according to claim 1, wherein
the film is transparent, having the opacity of at most 20%.

11. The film according to claim 1, wherein
the first layer comprises at least one material (i) having a glass transition temperature less than the activation temperature and/or (ii) not having a glass transition temperature.

12. A labelled item, the item comprising:
a body;
a first layer of first material; and
a second layer of second material, wherein
the second layer is arranged in between the body and the first layer,
the size of the area of body that is covered by the second layer is A_{b2},
the size of the area of second layer that is covered by the first layer is A₂₁,
the ratio the these areas, A_{b2}/A₂₁, is between 0.95 and 1.05,
the first layer comprises material that is resistant to temperatures higher than 90° C.,
the second layer comprises thermally activated material, wherein the thermally activated material has been thermally activated, and
the first layer and/or the second layer comprises material capable of absorbing electromagnetic energy.

13. The labelled item according to claim 12, wherein
the first layer comprises plastic polymer.

14. The labelled item according to claim 12, wherein
the first layer is opaque having the opacity of at least 70%.

15. The labelled item according to claim 12, wherein
the first layer is transparent, having the opacity of at most 20%.

16. The labeled item according to claim 10, wherein at least one of the first layer or the second layer comprises, on a boundary,
markings indicative of laser cutting.

17. The labeled item according to claim 16, wherein the markings comprise as solidified pieces of melted material of the first and/or the second layer.

18. The labelled item according to claim 12, wherein
the body comprises at least one of polyethylene, high density polyethylene, low density polyethylene, polyethylene terephthalate, polyvinyl chloride, glass, or cardboard.

19. The labelled item of claim 20, wherein
the body comprises an inlet, wherein the cross sectional area of the inlet is at most half of the cross sectional area of the body; whereby
the body has the shape of a bottle.

20. The labelled item according to claim 12, wherein
the body is transparent, having the opacity of at most 10%.

21. The labelled item according to claim 17, wherein
the combination of the second layer and the first layer is transparent.

22. A method for labelling a body to form a labelled item, the method comprising:
providing a film suitable for thermal activation and laser cutting, the film having
a length, a width, and a thickness, wherein the thickness is smaller than the length and the width, and the film comprising
a first surface and an opposite second surface,
a first layer having the length and the width and comprising the first surface,
a second layer arranged onto the first layer and comprising the second surface, wherein
the second layer comprises thermally activatable material such that
in a thermal activation, wherein the temperature of the thermally activatable material rises above an activation temperature Ta, the adhesion properties of the material change such that before said thermal activation, the material of the second layer is solid and non-sticky, and
after said thermal activation, the material of the second layer is viscous and forms an active adhesive; wherein
the activation temperature Ta, is from 75° C. to 135° C.;
the first layer comprises material that is resistant to temperatures higher than Ta, and
the first layer and/or the second layer comprises material capable of absorbing electromagnetic energy, whereby the film is suitable for laser cutting; and
heating the film or a cut label to activate the material of the second layer;
cutting, by laser, a label from the film, whereby the label comprises a first layer and a second layer, wherein the first layer and the second layer have been parts of the layers of the film; and
attaching the second layer of the label onto a body.

23. The method according to claim 22, further comprising:
heating the film or a cut label to a temperature from 75° C. to 135° C.

24. The method according to claim 23, wherein the film or cut label is heated to a temperature from 90° C. to 125° C.

25. The method according to claim 22, further comprising:
pre-heating the body before attaching the second layer of the label onto the body.

26. The method according to claim 22, further comprising:
using an apparatus to heat the film or the label; and
using the same apparatus to laser cut the label.

27. The method according to claim 26, comprising
using the same apparatus to attach the label to the body.

28. The method according to claim 19, wherein
the film is oriented in at least one direction of orientation, the method further comprising
using a roller to separate the label from the remaining film, such that
the direction of orientation is arranged perpendicular to the axis of rotation of the roller.
